(19) United States
(12) Patent Application Publication
(10) Pub. No.: US 2026/0045593 A1
(43) Pub. Date: Feb. 12, 2026

(54) THERMAL INSULATING MATERIAL

(71) Applicant: NITTO DENKO CORPORATION, Osaka (JP)

(72) Inventors: Maho KAWAKAMI, Ibaraki-shi, Osaka (JP); Kakeru TSUJITA, Ibaraki-shi, Osaka (JP)

(73) Assignee: NITTO DENKO CORPORATION, Osaka (JP)

(21) Appl. No.: 19/101,278

(22) PCT Filed: Aug. 14, 2023
(86) PCT No.: PCT/JP2023/029429

§ 371 Date: Feb. 5, 2025

(30) Foreign Application Priority Data
Aug. 19, 2022 (JP) 2022-131070

(51) Int. Cl. H01M 10/658; H01M 10/0525

(52) U.S. Cl. CPC H01M 10/658; H01M 10/0525; H01M 2220/20; H01M 2220/30

(57) ABSTRACT

Provided is a thermal insulating material including a thermal insulating layer. The thermal insulating layer contains silicon dioxide particles having a BET specific surface area of 90 m²/g or more and less than 380 m²/g, inorganic fiber, and at least one kind of non-polymeric dispersant represented by Formula (A1), (A2), (A3), or (A4) as follows.

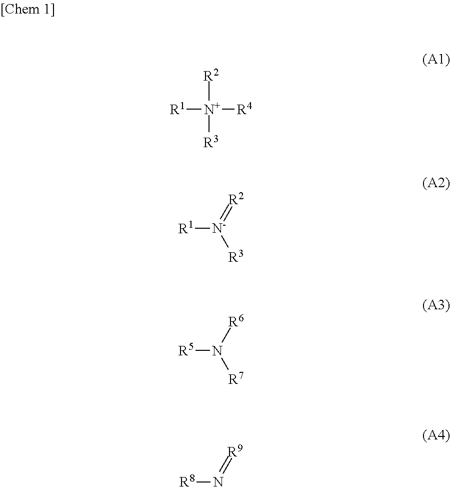

### TECHNICAL FIELD

The present invention relates to a thermal insulating material, more particularly a thermal insulating material including a thermal insulating layer containing a specific non-polymeric dispersant. This application claims the priority based on Japanese Patent Application No. 2022-131070, filed on Aug. 19, 2022, the content of which is herein incorporated by reference in its entirety.

### BACKGROUND ART

Nonaqueous electrolyte secondary batteries such as lithium ion batteries have been widely used as electric sources of electric conveyances such as hybrid vehicles and electric vehicles; mobile electronics such as mobile terminals, mobile phones, and laptop PCs; wearable devices and the like. For example, in a module or a pack of lithium ion batteries which is equipped in an electric vehicle or the like, a plurality of cells forms a stack, and thus sometimes a thermal insulating material is placed between adjacent cells in order to avoid direct contact between the cells and further make the cells thermally insulated from one another.

Patent Document 1 describes that a thermal insulating sheet to be inserted between battery cells in an assembled battery is produced by compounding first particles occupied by silica particles, second particles formed of titania or the like, and inorganic fiber having a linear or needle shape and subjecting them to wet sheet forming, and exhibits an excellent thermal insulating property even in a high-temperature range of 500° C. or higher.

### CITATION LIST

### Patent Literature

[Patent Document 1]Japanese Patent Application No. 2021-34278

### SUMMARY OF INVENTION

### Technical Problem

The inventors have found that a thermal insulating material containing inorganic fiber in addition to silicon dioxide particles has a high thermal insulating property and excellent mechanical strength. Such a thermal insulating material can be produced by mixing silicon dioxide particles and inorganic fiber in a solvent and then subjecting them to application and shaping. The inventors have revealed that use of e.g., hydrophilic fumed silica facilitates an increase in viscosity of a mixture liquid, and that the increased viscosity inhibits mixing and significantly reduces productivity. Particularly, with regard to a thermal insulating material containing inorganic fiber, increased viscosity of a mixture liquid leads to breakage of inorganic fiber, thus requiring further attention. To deal with such a problem of increased viscosity of a mixture liquid, addition of a dispersant can also be contemplated. But the inventors have further revealed that merely adding a dispersant results in difficulty in appropriately retaining viscosity and further creates a new problem of reducing a thermal insulating property of a thermal insulating material, when hydrophilic fumed silica with a large specific surface area is employed, or when a mixture liquid containing inorganic fiber has a relatively high concentration.

An embodiment of the present invention has an object to provide a thermal insulating material excellent in a thermal insulating property and productivity.

### Solution to Problem

This specification provides a thermal insulating material including a thermal insulating layer containing silicon dioxide particles, inorganic fiber, and at least one kind of non-polymeric dispersant represented by Formula (A1), (A2), (A3), or (A4) as described below. The silicon dioxide particles have a BET specific surface area of 90 m²/g or more and less than 380 m²/g.

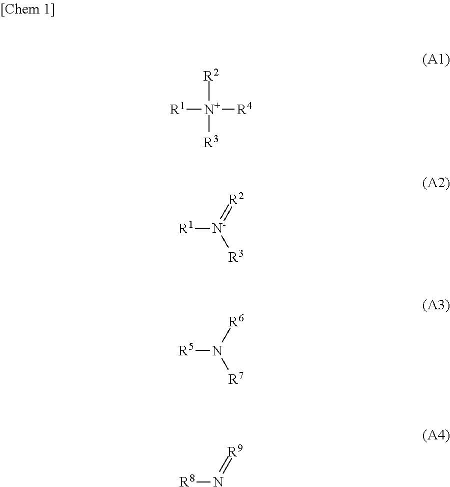

wherein, in Formulae (A1) and (A2), R¹, R², R³, and R⁴ each independently represents a hydrocarbon group optionally including a hetero atom; a total number of carbon atoms derived by combining hydrocarbon groups R¹, R², R³, and R⁴ is 8 to 40; and hydrocarbon groups R¹, R², R³, and R⁴ optionally bind to one another to form a cyclic structure;
wherein, in Formula (A3), R⁵ represents a hydrocarbon group optionally including a hetero atom; R⁶ and R⁷ each independently represents a hydrogen atom or a hydrocarbon group optionally including a hetero atom; a total number of carbon atoms derived by combining hydrocarbon groups R⁵, R⁶, and R⁷ is 8 to 40; and hydrocarbon groups R⁵, R⁶, and R⁷ optionally bind to one another to form a cyclic structure; and
wherein, in Formula (A4), R⁸ and R⁹ each independently represents a hydrocarbon group optionally including a hetero atom; a total number of carbon atoms derived by combining hydrocarbon groups R⁸ and R⁹ is 8 to 40; and hydrocarbon groups R⁸ and R⁹ optionally bind to one another to form a cyclic structure.

According to a thermal insulating material having such a configuration, a thermal insulating layer contains a particular non-polymeric dispersant in addition to silicon dioxide particles and inorganic fiber, thereby allowing effectively preventing an increase in viscosity of a mixture liquid thereof and improving productivity. Furthermore, the silicon dioxide particles have a BET specific surface area in the range of 90 m²/g or more and less than 380 m²/g, thereby preferably facilitating combination of prevention of an increase in viscosity of the mixture liquid with a thermal insulating property. Accordingly, an embodiment of the present invention can provide a thermal insulating material excellent in a thermal insulating property and productivity.

In some preferred embodiments, the non-polymeric dispersant is present in a content of 0.01% by mass to 5% by mass in the thermal insulating layer. This can lead to suppress an increase in viscosity of the mixture liquid while well suppressing a decrease in the thermal insulating property.

In some embodiments, as the silicon dioxide particles, at least one kind selected from the group consisting of e.g., dry silica (dry-process silica), wet silica (wet-process silica), and silica aerogel can be used.

In some embodiments, as the silicon dioxide particles, at least one kind selected from the group consisting of hydrophilic fumed silica and hydrophobic fumed silica can be preferably employed. More preferred is hydrophilic fumed silica.

In some embodiments, the silicon dioxide particles preferably has an average primary particle diameter of 100 nm or less. When the average primary particle diameter of the silicon dioxide particles is such a value or less, a good thermal insulating property is likely to be ensured.

In some embodiments, as the inorganic fiber, at least one kind selected from the group consisting of heatproof glass fiber and biosoluble inorganic fiber can be preferably employed. In particular, glass fiber is preferred.

In some embodiments, the thermal insulating layer preferably has a density of 0.2 g/cm³ to 0.5 g/cm³. When the thermal insulating layer has a density within such a range, a good thermal insulating property and mechanical strength are likely to be ensured.

In some preferred embodiments, the thermal insulating layer has a thermal conductivity of 0.045 W/(m·K) or less under a pressurized condition of 2 MPa at 80° C. Inclusion of such a thermal insulating layer is advantageous in view of providing a thermal insulating material that exhibits a good thermal insulating property.

In some preferred embodiments, the thermal insulating layer has a thermal conductivity of 0.08 W/(m·K) or less under a pressurized condition of 2 MPa at 600° C. Inclusion of such a thermal insulating layer is advantageous in view of providing a thermal insulating material that exhibits a good thermal insulating property even under a high-temperature condition.

Athermal insulating material according to some embodiments further includes a covering layer formed of a resin film, and the thermal insulating layer and the covering layer are stacked. The covering layer may serve to prevent release of silicon dioxide particles or the like in the thermal insulating layer, and to protect the thermal insulating layer. An exemplary embodiment of the thermal insulating material including the covering layer can be an embodiment in which the thermal insulating material comprises two or more of the covering layers forming a stack, and in which the two or more covering layers sandwich and enclose the thermal insulating layer among themselves in a thickness direction, and seal a gap between the covering layers. The covering layer may have a vent hole to connect the gap to an exterior space.

The thermal insulating material disclosed herein can be preferably employed in, e.g., an embodiment of being placed between cells in a battery module, by leveraging merits of exerting a high thermal insulating property and excellent mechanical strength.

The specification also provides a method of producing a thermal insulating material including:
a mixing step of mixing silicon dioxide particles, inorganic fiber, and a non-polymeric dispersant represented by Formula (A1), (A2), (A3), or (A4) as follows in a solvent to prepare a mixture liquid,
an applying step of applying the mixture liquid prepared in the mixing step to provide an applied film, and
a shaping step of shaping the applied film provided in the applying step to provide a thermal insulating layer. This production method can be preferably employed to produce any of the thermal insulating materials disclosed herein.

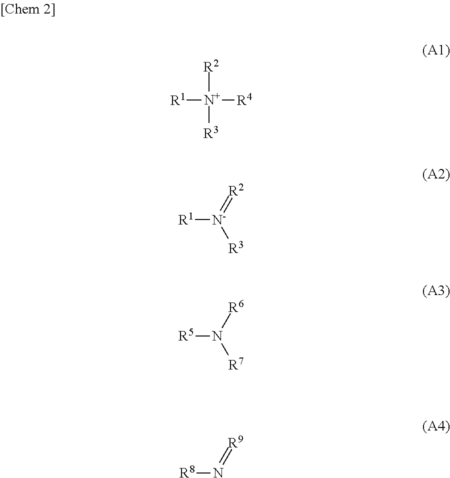

wherein, in Formulae (A1) and (A2), R¹, R², R³, and R⁴ each independently represents a hydrocarbon group optionally including a hetero atom; a total number of carbon atoms derived by combining hydrocarbon groups R¹, R², R³, and R⁴ is 8 to 40; and hydrocarbon groups R¹, R², R³, and R⁴ optionally bind to one another to form a cyclic structure;
wherein, in Formula (A3), R⁵ represents a hydrocarbon group optionally including a hetero atom; R⁶ and R⁷ each independently represents a hydrogen atom or a hydrocarbon group optionally including a hetero atom; a total number of carbon atoms derived by combining hydrocarbon groups R⁵, R⁶, and R⁷ is 8 to 40; and hydrocarbon groups R⁵, R⁶, and R⁷ optionally bind to one another to form a cyclic structure; and
wherein, in Formula (A4), R⁸ and R⁹ each independently represents a hydrocarbon group optionally including a hetero atom; a total number of carbon atoms derived by combining hydrocarbon groups R⁸ and R⁹ is 8 to 40; and hydrocarbon groups R⁸ and R⁹ optionally bind to one another to form a cyclic structure.

In some embodiments, the non-polymeric dispersant is added to the mixture liquid in an amount of preferably 0.05 parts by mass to 5 parts by mass relative to 100 parts by mass of the silicon dioxide particles. When the additive amount of the non-polymeric dispersant falls within such a range, an admixture liquid is dispersively stabilized, and the thermal insulating material has a better thermal insulating property.

In some embodiments, the solvent is a protic solvent. An embodiment with use of a protic solvent has a tendency to better exert an effect from applying the production method disclosed herein.

In some embodiments, the solvent has a surface tension of less than 73 mN/m. When the solvent has a surface tension within such a range, the thermal insulating property and mechanical strength are better improved.

### BRIEF DESCRIPTION OF DRAWINGS

FIG. 1 is a perspective view schematically illustrating an exemplary battery module in which a thermal insulating material according to an embodiment is placed between cells.

FIG. 2 is a cross-sectional view taken along the line II-II in FIG. 1.

FIG. 3 is a perspective view schematically illustrating a thermal insulating material according to an embodiment.

FIG. 4 is a cross-sectional view taken along the line IV-IV in FIG. 3.

FIG. 5 is a cross-sectional view schematically illustrating a thermal insulating material according to another embodiment.

FIG. 6 is a cross-sectional view schematically illustrating a thermal insulating material according to another embodiment.

FIG. 7 is a cross-sectional view schematically illustrating a thermal insulating material according to another embodiment.

### DESCRIPTION OF EMBODIMENTS

Preferred embodiments of the present invention will be described below. Matters that are other than those particularly mentioned herein but are necessary for implementation of the present invention can be recognized by those skilled in the art based on teachings for practice of the present invention described herein and common technical knowledge at the time of filing. The present invention can be implemented based on the contents disclosed herein and common technical knowledge in the art. In the drawings below, members or sites producing the same effects may be described with a common reference numeral, and duplicated descriptions may be omitted or simplified. The embodiments depicted in the drawings are schematized for explicitly illustrating the present invention, and do not necessarily represent the accurate size or reduction scale of a product actually provided.

The inventors have found that a thermal insulating material containing inorganic fiber in addition to silicon dioxide particles has a high thermal insulating property and excellent mechanical strength. Such a thermal insulating material can be produced by mixing silicon dioxide particles and inorganic fiber in a solvent and then subjecting them to application and shaping. Nevertheless, for example, mixing in a protic solvent with use of hydrophilic fumed silica particularly facilitates an increase in viscosity of the mixture liquid, because of binding of hydrophilic fumed silica and a protic solvent via hydrogen bonding. Extremely high viscosity would make mixing itself difficult and significantly reduces productivity. Particularly, with regard to a thermal insulating material containing inorganic fiber, increased viscosity of a mixture liquid leads to breakage of inorganic fiber, thus requiring further attention. To deal with such a problem of increased viscosity of a mixture liquid, addition of a dispersant can also be contemplated. But the inventors have revealed that use of hydrophilic fumed silica with a relatively large specific surface area results in particular difficulty in prevention of an increase in viscosity, and further creates a new problem in that merely adding a large amount of a dispersant for preventing an increase in viscosity leads to reduction in a thermal insulating property of a thermal insulating material thus obtained. Furthermore, when a mixture liquid containing inorganic fiber and having a relatively high concentration is employed, it is more difficult to deal with the problem of increased viscosity.

The inventors found that addition of a particular non-polymeric dispersant, i.e., “a non-polymeric dispersant represented by Formula (A1), (A2), (A3), or (A4)”, in a mixture liquid can effectively prevent increase in viscosity to maintain productivity, and is also highly effective to solve a problem of reduction in a thermal insulating property of a thermal insulating material. Moreover, the inventors found that addition of the non-polymeric dispersant reduces strain of the thermal insulating material on being compressed with fixed pressures, without need of an increased density of a thermal insulating material thus obtained. This is an effect to lead to cost reduction, and also provides athermal insulating material with improved cost performance.

Detailed description will now be provided for “silicon dioxide particles”, “inorganic fiber”, “a non-polymeric dispersant represented by Formula (A1), (A2), (A3), or (A4)(hereinafter sometimes also omitted as “a non-polymeric dispersant)”, and the like in a thermal insulating layer.

Silicon dioxide (silica, SiO₂) can be classified into crystalline silica, amorphous silica, and the like for structural characteristics, and into natural silica, synthetic silica, and the like depending on a way of acquisition. Furthermore, synthetic silica can be classified into dry silica, wet silica, silica aerogel, and the like depending on a production method; dry silica can be further classified into silica produced by combustion, silica produced by arc discharge, and the like, and wet silica can be classified into silica produced by gelling, silica produced by precipitation, and the like. The type of the silicon dioxide particles in the present invention is not particularly limited, and is preferably dry silica or silica aerogel. As a type of dry silica, fumed silica is more preferred; among fumed silica, hydrophilic fumed silica is particularly preferred. Herein, hydrophilic fumed silica (fumed silica) refers to fumed silica majorly having hydrophilic silanol groups (Si—OH) on a surface, and generally refers to fumed silica having silanol groups not substituted with hydrophobic groups by surface treatment or the like. The silicon dioxide particles can generally be present as aggregates derived by aggregation of primary particles, or as conglomerated particles derived by further aggregation of the aggregates. Nevertheless, in the thermal insulating layer, the silicon dioxide particles may be dispersed in form of primary particles, aggregates, conglomerated particles, or combination thereof.

The average primary particle diameter of the silicon dioxide particles is not particularly limited, and is usually 1 nm to 100 nm, preferably 2 nm or more, more preferably 4 nm or more, and preferably 80 nm or less, more preferably 40 nm or less, even more preferably 30 nm or less, particularly preferably 20 nm or less. When the silicon dioxide particles are fumed silica, the average primary particle diameter is usually 1 nm to 40 nm, preferably 2 nm or more, more preferably 4 nm or more, and preferably 30 nm or less, more preferably 20 nm or less, even more preferably 18 nm or less. When the silicon dioxide particles are silica aerogel, the average primary particle diameter is usually 1 nm to 20 nm, preferably 18 nm or less, more preferably 10 nm or less. When the silicon dioxide particles has an average primary particle diameter within these ranges, the good thermal insulating property is likely to be ensured. Examples of a method of obtaining the average primary particle diameter of the silicon dioxide particles include a measurement method with use of an electron microscope such as a scanning electron microscope (SEM) or a transmission scanning electron microscope (TEM). A particular example is a method of randomly selecting silicon dioxide particles under an electron microscope, measuring their particle diameters, and calculating an average value of the numerical values thus obtained. A particle diameter to be employed is a diameter in a spherical particle, an intermediate value between a minor axis and a mayor axis in an elliptical particle, or an intermediate value between a short side and a long side in an indeterminate-shaped particle.

The average particle diameter of secondary aggregates (aggregates of primary particles) of the silicon dioxide particles is not particularly limited, and is usually 0.1 μm to 100 μm, preferably 1 μm or more, more preferably 2 μm or more, and preferably 90 m or less, more preferably 80 μm or less. Examples of a method of obtaining the average particle diameter of secondary aggregates of the silicon dioxide particles include a measurement method with use of the same method as for the primary particle diameter.

The BET specific surface area of the silicon dioxide particles is 90 m²/g or more and less than 380 m²/g, preferably 130 m²/g or more, more preferably 175 m²/g or more, even more preferably 200 m²/g or more, and preferably 350 m²/g or less, more preferably 320 m²/g or less, even more preferably 300 m²/g or less. When the silicon dioxide particles has a BET specific surface area within these range, the thermal insulating property is also likely to be ensured under high-temperature and high-humidity conditions. The BET specific surface area can be measured by a multipoint nitrogen absorption (BET) technique in accordance with a measurement method conforming to the International Organization for Standardization (ISO) 5794/1. For example, “AEROSIL 380” manufactured by Nippon Aerosil Co., Ltd. has a BET specific surface area of 380 m²/g as the nominal value, and is written as 350 m²/g to 410 m²/g in consideration of an error. In such a case, the nominal value of 380 m²/g is considered as a basis herein.

The apparent specific gravity of the silicon dioxide particles is not particularly limited, and is usually 30 g/L to 130 g/L, preferably 40 g/L or more, more preferably 50 g/L or more, and preferably 100 g/L or less, more preferably 80 g/L or less, even more preferably 60 g/L or less. The apparent specific gravity of the silicon dioxide particles is exemplarily a numerical value derived by filling the silicon dioxide particles in a container capable of measuring a volume such as a 250 mL graduated cylinder, measuring a filled mass (X g) and a filled volume (Y mL) of the silicon dioxide particles, and dividing the filled mass by the filled volume ([apparent specific gravity (g/L)]=X/Y×1000).

Examples of the silicon dioxide particles include hydrophilic fumed silica including AEROSIL series (manufactured by Nippon Aerosil Co., Ltd.) such as AEROSIL 50, 90, 130, 200, 300, and 380, REOLOSIL series (manufactured by Tokuyama Corporation) such as QS-09, QS-10, QS-102, QS-20, QS-30, and QS-40, and HDK series (manufactured by Wacker Asahikasei Silicone Co., Ltd.) such as HDKV15, N20, T30, and T40; hydrophobic fumed silica including AEROSIL series (manufactured by Nippon Aerosil Co., Ltd.) such as AEROSIL R972 and R976S, HDK series (manufactured by Wacker Asahikasei Silicone Co., Ltd.) such as HDK H15, H20, and H30; and silica aerogel including AIRLICA (manufactured by Tokuyama Corporation). The thermal insulating layer may contain one type of the silicon dioxide particles or two or more types of the silicon dioxide particles.

The silicon dioxide particle content in the thermal insulating layer is not particularly limited, and is usually 50% by mass to 99.5% by mass, preferably 60% by mass or more, more preferably 70% by mass or more, even more preferably 80% by mass or more, and preferably 95% by mass or less, more preferably 90% by mass or less, even more preferably 85% by mass or less. When the silicon dioxide particle content falls within these ranges, a good thermal insulating property and mechanical strength are likely to be ensured.

The type of the inorganic fiber is not particularly limited, and examples thereof include silica fiber, glass fiber, alumina fiber, silica-alumina fiber, silica-alumina-magnesia fiber, biosoluble inorganic fiber, glass fiber, zirconia fiber, alkaline earth metal silicate fiber, alkali earth silicate (AES) fiber, glass wool, rock wool, and basalt fiber. When the inorganic fiber is as listed above, thermostability is improved. The thermal insulating layer may contain one type of the inorganic fiber, or two or more types of the inorganic fiber.

The inorganic fiber content in the thermal insulating layer is not particularly limited, and is usually 0.5% by mass to 50% by mass, preferably 1% by mass or more, more preferably 3% by mass or more, even more preferably 5% by mass or more, and preferably 40% by mass or less, more preferably 35% by mass or less, even more preferably 30% by mass or less. When the fiber content falls within these ranges, good thermal resistance is likely to be ensured, and the thermal insulating layer is easily produced.

The average fiber length of the inorganic fiber is not particularly limited, and is usually 0.05 mm to 50 mm, preferably 0.5 mm or more, more preferably 1.0 mm or more, even more preferably 2 mm or more, and preferably 25 mm or less, more preferably 13 mm or less, even more preferably 10 mm or less, and may be 8 mm or less, or 6 mm or less. When the fiber has an average fiber length within these ranges, the thermal insulating layer is produced easily.

The average fiber diameter of the inorganic fiber is not particularly limited, and is usually 0.1 μm to 50 μm, preferably 1 μm or more, more preferably 5 μm or more, even more preferably 7 μm or more, and preferably 25 μm or less, more preferably 20 μm or less, even more preferably 15 μm or less. When the fiber has an average fiber diameter within these ranges, a good thermal insulating property and mechanical strength are likely to be ensured.

The inorganic fiber preferably contains inorganic fiber with a fiber length of 6 mm or more and less than 35 mm. The ratio of the number of inorganic fiber fibrils having a fiber length of 6 mm or more and less than 35 mm relative to the number of all fibrils of the inorganic fiber is not particularly limited, and is usually 30% to 100%, preferably 95% or less, and preferably 35% or more, more preferably 40% or more, even more preferably 50% or more. When the ratio of fiber having the aforementioned fiber length falls within these ranges, a good thermal insulating property and mechanical strength are likely to be ensured.

The thermal insulating layer may contain organic fiber in addition to inorganic fiber. Specific examples of the organic fiber include felt made of cellulose fiber, polyester, polypropylene, or the like. Use of the organic fiber may be advantageous in view of increase in a cushioning property, improvement in durability to repeated pressure fatigue, and the like. The organic fiber content in the thermal insulating layer can be appropriately set so as to provide a desired effect of use, and may be, e.g., more than 0 parts by mass, 1 part by mass or more, 4 parts by mass or more, 8 parts by mass or more, or 16 parts by mass or more relative to 100 parts by mass of inorganic fiber. Meanwhile, in some embodiments, in view of thermostability and the like, the organic fiber content in the thermal insulating layer is suitably less than 100 parts by mass, advantageously less than 50 parts by mass, and may be less than 20 parts by mass, less than 10 parts by mass, less than 5 parts by mass, or less than 1 part by mass relative to 100 parts by mass of inorganic fiber, or the thermal insulating layer may contain no organic fiber.

The non-polymeric dispersant is a compound represented by Formula (A1), (A2), (A3), or (A4) as follows:

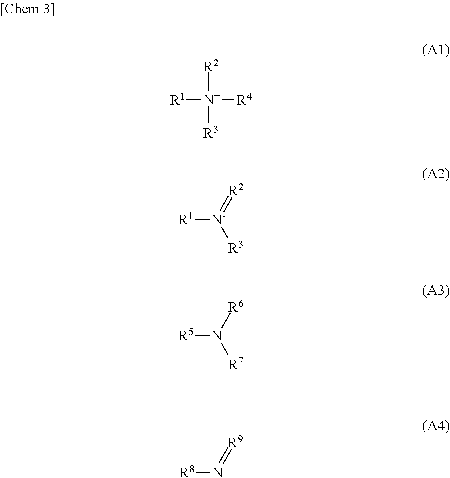

wherein, in Formulae (A1) and (A2), R¹, R², R³, and R⁴ each independently represents a hydrocarbon group optionally including a hetero atom; a total number of carbon atoms derived by combining hydrocarbon groups R¹, R², R³, and R⁴ is 8 to 40; and hydrocarbon groups R¹, R², R³, and R⁴ optionally bind to one another to form a cyclic structure;
wherein, in Formula (A3), R⁵ represents a hydrocarbon group optionally including a hetero atom; R⁶ and R⁷ each independently represents a hydrogen atom or a hydrocarbon group optionally including a hetero atom; a total number of carbon atoms derived by combining hydrocarbon groups R⁵, R⁶, and R⁷ is 8 to 40; and hydrocarbon groups R⁵, R⁶, and R⁷ optionally bind to one another to form a cyclic structure; and
wherein, in Formula (A4), R⁸ and R⁹ each independently represents a hydrocarbon group optionally including a hetero atom; a total number of carbon atoms derived by combining hydrocarbon groups R⁸ and R⁹ is 8 to 40; and hydrocarbon groups R⁸ and R⁹ optionally bind to one another to form a cyclic structure.

As used herein, “non-polymeric” means a so-called “low-molecular compound”, which is a molecule whose structure contains no polymer generated by polymerization reaction. Dispersants may be classified into 1) high-molecular dispersants, 2) surfactant dispersants (low-molecular dispersants), 3) inorganic dispersants, and the like, and the non-polymeric dispersant corresponds to “2) surfactant dispersants (low-molecular dispersants)”. As represented by Formulae (A1), (A2), (A3), and (A4), the non-polymeric dispersant can refer to a so-called cationic surfactant such as a quaternary ammonium salt, an amine salt, or a pyridinium salt. In the thermal insulating layer, the non-polymeric dispersant may be present in form of a salt combined with a counter ion, and may be present as a free compound or an ion. Examples of the salt include an ammonium salt of a dispersant represented by Formula (A1) with a counter ion (e.g., a chloride ion, a bromide ion, and an ethyl sulfate ion), and an amine salt of a dispersant represented by Formula (A3) and acetic acid.

Formulae (A1) to (A4) will be described in detail below.

In Formulae (A1) and (A2), R¹, R², R³, and R⁴ each independently represents “a hydrocarbon group optionally including a hetero atom”. This hydrocarbon group does not always have a linear structure and may have a branched structure, a cyclic structure, a carbon-carbon unsaturated bond (a carbon-carbon double bond or a carbon-carbon triple bond) or the like, and may be any of a saturated hydrocarbon group, an unsaturated hydrocarbon group, an alicyclic saturated hydrocarbon group, an alicyclic unsaturated hydrocarbon group, an aromatic hydrocarbon group and the like.

The phrase “a hydrocarbon group optionally including a hetero atom” also means that a carbon atom or a hydrogen atom in the hydrocarbon group may be converted to a hetero atom, or that a functional group including a hetero atom may be formed at an end or inside of the hydrocarbon group. Specific examples of a hetero atom include a nitrogen atom (N), an oxygen atom (O), and a sulfur atom (S), and preferred examples thereof include a nitrogen atom and an oxygen atom. For example, the phrase “a hydrocarbon group optionally including a nitrogen atom” means that a carbon atom or a hydrogen atom in the hydrocarbon group may be converted to a nitrogen atom, and that a functional group containing a nitrogen atom, such as a primary amino group (—NH₂), a secondary amino group (—NH—), a tertiary amino group (—N<), or an imino group (═N—), may be formed at an end or inside of the hydrocarbon group. The phrase “a hydrocarbon group optionally including an oxygen atom” means that a carbon atom or a hydrogen atom in the hydrocarbon group may be converted to an oxygen atom, and that a functional group containing an oxygen atom, such as an ether bond (—O—), a carbonyl group (═O), or a hydroxy group (—OH), may be formed at an end or inside of the hydrocarbon group. The phrase “a hydrocarbon group optionally including a sulfur atom” means that a carbon atom or a hydrogen atom in the hydrocarbon group may be converted to a sulfur atom, and that a functional group containing a sulfur atom, such as a thioether bond (—S—) or a thiol group (—SH), may be formed at an end or inside of the hydrocarbon group.

When the aforementioned hydrocarbon groups includes a hetero atom, the number of hetero atoms in a single hydrocarbon group (e.g., R⁵ in Formula (A3)) may be one, or two or more. Usually, the number of hetero atoms in a single hydrocarbon group is suitably six or less, preferably five or less or four or less, more preferably three or less or two or less. The type of hetero atom in a single hydrocarbon group may be one, or two or more.

Hydrocarbon groups R¹, R², R³, and R⁴ may also bind to one another to form a cyclic structure, and examples of those that “bind to one another to form a cyclic structure” include a cation in hexadecyl pyridinium chloride represented by the formula as depicted below. Hexadecyl pyridinium chloride is a salt of a cation corresponding to Formula (A2) and a chloride ion, in which the cation can be considered to include R¹ in Formula (A2) as a hexadecyl group, and R² and R3 binding to one another to form a cyclic structure. The cyclic structure thus formed may have a carbon-carbon unsaturated bond, and hexadecyl pyridinium chloride can be considered to include the cyclic structure thus formed having a carbon-carbon unsaturated bond and forming a pyridinium structure.

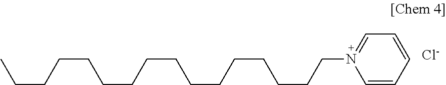

In Formulae (A1) and (A2), the total number of carbon atoms (hereinafter also referred to as “the total number of Cs”) derived by combining hydrocarbon groups R¹, R², R³, and R⁴ is 8 to 40 (e.g., 12 to 40). In terms of a cation in hexadecyl pyridinium chloride as mentioned above, R¹ is a hexadecyl group and thus provides the number of carbon atoms as 16, and R² and R³ bind to one another to form a pyridinium structure and thus provide the number of carbon atoms as 5. Accordingly, in a cation of hexadecyl pyridinium chloride, the total number of carbon atoms derived by combining hydrocarbon groups R¹, R², R³, and R⁴ is 16+5=21.

In Formulae (A1) and (A2), the total number of carbon atoms derived by combining hydrocarbon groups R¹, R², R³, and R⁴ is 8 to 40 (e.g., 12 to 40). The total number of carbon atoms is usually, advantageously 9 or more, preferably 10 or more (e.g., 11 or more or 12 or more). In some embodiments, the total number of carbon atoms is preferably 13 or more, more preferably 14 or more, even more preferably 15 or more, and preferably 35 or less, more preferably 25 or less, even more preferably 20 or less. When the total number of carbon atoms falls within these ranges, the admixture liquid can be dispersively stabilized, and the thermal insulating material has a good thermal insulating property. In some embodiments, the total number of carbon atoms is suitably 18 or less, and may be 16 or less, 14 or less, 13 or less, or 12 or less. As far as suitable dispersive stability is provided, avoiding excess in the total number of carbon atoms can be advantageous in view of flowability of the admixture liquid (e.g., improved flowability caused by increased consistency).

In at least one hydrocarbon group in R¹, R², R³, and R⁴ in Formulae (A1) and (A2), the number of carbon atoms is usually 5 to 35 or 6 to 35 (e.g., 8 to 35). In some embodiments, the number of carbon atoms is preferably 10 or more, more preferably 11 or more, even more preferably 12 or more, and preferably 30 or less, more preferably 20 or less, even more preferably 18 or less, and may be 16 or less, 14 or less, 12 or less, 10 or less, or 9 or less. When the number of carbon atoms falls within these ranges, the admixture liquid is dispersively stabilized with ease.

In Formula (A3), R⁵ represents a hydrocarbon group, and R⁶ and R⁷ each independently represents “a hydrocarbon group optionally including a hetero atom” or “a hydrogen atom”. These hydrocarbon groups have the same meaning as hydrocarbon groups in Formulae (A1) and (A2) as previously described, and may bind to one another to form a cyclic structure.

In Formula (A3), the total number of carbon atoms (the total number of Cs) derived by combining hydrocarbon groups R⁵, R⁶, and R⁷ is 8 to 40 (e.g., 12 to 40). The total number of carbon atoms is usually, advantageously 9 or more, preferably 10 or more (e.g., 11 or more or 12 or more). In some embodiments, the total number of carbon atoms is preferably 13 or more, more preferably 14 or more, even more preferably 15 or more, and preferably 35 or less, more preferably 25 or less, even more preferably 20 or less. When the total number of carbon atoms falls within these ranges, the admixture liquid can be dispersively stabilized, and the thermal insulating material has a good thermal insulating property. In some embodiments, the total number of carbon atoms is suitably 18 or less, and may be 16 or less, 14 or less, 13 or less, or 12 or less. As far as suitable dispersive stability is provided, avoiding excess in the total number of carbon atoms can be advantageous in view of flowability of the admixture liquid (e.g., improved flowability caused by increase in consistency).

In Formula (A3), the number of carbon atoms in at least one hydrocarbon group in R⁵, R⁶, and R⁷ is usually 6 to 35 (e.g., 8 to 35), preferably 10 or more, more preferably 11 or more, even more preferably 12 or more, and preferably 30 or less, more preferably 20 or less, even more preferably 18 or less. When the number of carbon atoms falls within these ranges, the admixture liquid is dispersively stabilized with ease.

In Formula (A4), R⁸ and R⁹ each independently represents “a hydrocarbon group optionally including a hetero atom”. These hydrocarbon groups have the same meaning as hydrocarbon groups in Formulae (A1) and (A2) as previously described, and may bind to one another to form a cyclic structure.

In Formula (A4), the total number of carbon atoms (the total number of Cs) derived by combining hydrocarbon groups R⁸ and R⁹ is 8 to 40 (e.g., 12 to 40). The total number of carbon atoms is usually, advantageously 9 or more, preferably 10 or more (e.g., 11 or more or 12 or more). In some embodiments, the total number of carbon atoms is preferably 13 or more, more preferably 14 or more, even more preferably 15 or more, and preferably 35 or less, more preferably 25 or less, even more preferably 20 or less. When the total number of carbon atoms falls within these ranges, the admixture liquid can be dispersively stabilized, and the thermal insulating material has a good thermal insulating property. In some embodiments, the total number of carbon atoms is suitably 18 or less, and may be 16 or less, 14 or less, 13 or less, or 12 or less. As far as suitable dispersive stability is provided, avoiding excess in the total number of carbon atoms can be advantageous in view of flowability of the admixture liquid (e.g., improved flowability caused by increased consistency).

In Formula (A4), the number of carbon atoms in at least one hydrocarbon group in R⁸ and R⁹ is usually 7 to 35 (e.g., 8 to 35), preferably 10 or more, more preferably 11 or more, even more preferably 12 or more, and preferably 30 or less, more preferably 20 or less, even more preferably 18 or less. When the number of carbon atoms falls within these ranges, the admixture liquid is dispersively stabilized with ease.

Examples of the non-polymeric dispersant represented by Formula (A1) include a non-polymeric dispersant represented by Formula (A1-1) or (A1-2) as follows:

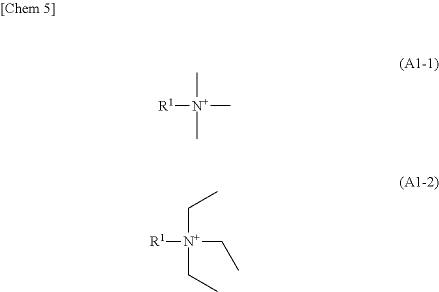

wherein in (Formula (A1-1), R¹ represents a hydrocarbon group in which the number of carbon atoms is 5 to 37 (e.g., 9 to 34) and that optionally includes a hetero atom (e.g., a nitrogen atom); and
wherein in Formula (A1-2), R¹ represents a hydrocarbon group in which the number of carbon atom is 2 to 34 (e.g., 9 to 34) and that optionally includes a hetero atom (e.g., a nitrogen atom).

Examples of a salt of the non-polymeric dispersant represented by Formula (A1) include nonyltrimethylammonium chloride (C₉H₁₉N⁺(CH₃)₃Cl), nonyltrimethylammonium bromide (C₉H₁₉N⁺(CH₃)₃Br), decyltrimethylammonium chloride (C₁₀H₂₁N⁺(CH₃)₃Cl), decyltrimethylammonium bromide (C₁₀H₂₁N⁺(CH₃)₃Br), undecyltrimethylammonium chloride (C₁₁H₂₃N⁺(CH₃)₃Cl), undecyltrimethylammonium bromide (C₁₁H₂₃N⁺(CH₃)₃Br), dodecyltrimethylammonium chloride (C₁₂H₂₅N(CH₃)₃Cl), dodecyltrimethylammonium bromide (C₁₂H₂₅N⁺(CH₃)₃Br), tridecyltrimethylammonium chloride (C₁₃H₂₇N⁺(CH₃)₃Cl), tridecyltrimethylammonium bromide (C₁₃H₂₇N⁺(CH₃)₃Br), tetradecyltrimethylammonium chloride (C₁₄H₂₉N⁺(CH₃)₃Cl), tetradecyltrimethylammonium bromide (C₁₄H₂₉N⁺(CH₃)₃Br), pentadecyltrimethylammonium chloride (C₁₅H₃₁N⁺(CH₃)₃Cl), pentadecyltrimethylammonium bromide (C₁₅H₃₁N⁺(CH₃)₃Br), hexadecyltrimethylammonium chloride (C₁₆H₃₃N⁺(CH₃)₃Cl), hexadecyltrimethylammonium bromide (C₁₆H₃₃N⁺(CH₃)₃Br), heptadecyltrimethylammonium chloride (C₁7H₃₅N(CH₃)₃Cl), heptadecyltrimethylammonium bromide (C₁7H₃₅N⁺(CH₃)₃Br), octadecyltrimethylammonium chloride (C₁₅H₃₇N⁺(CH₃)₃Cl), octadecyltrimethylammonium bromide (C₁₈H₃₇N⁺(CH₃)₃Br), nonadecyltrimethylammonium chloride (C₁₉H₃₉N⁺(CH₃)₃Cl), nonadecyltrimethylammonium bromide (C₁₉H₃₉N⁺(CH₃)₃Br), icosyltrimethylammonium chloride (C₂₀H₄₁N⁺(CH₃)₃Cl), icosyltrimethylammonium bromide (C₂₀H₄₁N⁺(CH₃)₃Br), heneicosyltrimethylammonium chloride (C₂₁H₄₃N⁺(CH₃)₃Cl), heneicosyltrimethylammonium bromide (C₂₁H₄₃N(CH₃)₃Br), docosyltrimethylammonium chloride (C₂₂H₄₅N⁺(CH₃)₃Cl), docosyltrimethylammonium bromide (C₂₂H₄₅N(CH₃)₃Br), tricosyltrimethylammonium chloride (C₂₃H₄₇N⁺(CH₃)₃Cl), tricosyltrimethylammonium bromide (C₂₃H₄₇N⁺(CH₃)₃Br), tetracosyltrimethylammonium chloride (C₂₄H₄₉N⁺(CH₃)₃Cl), tetracosyltrimethylammonium bromide (C₂₄H₄₉N⁺(CH₃)₃Br), pentacosyltrimethylammonium chloride (C₂₅H₅₁N⁺(CH₃)₃Cl), pentacosyltrimethylammonium bromide (C₂₅H₅₁N⁺(CH₃)₃Br), hexacosyltrimethylammonium chloride (C₂₆H₅₃N⁺(CH₃)₃Cl), hexacosyltrimethylammonium bromide (C₂₆H₅₃N⁺(CH₃)₃Br), heptacosyltrimethylammonium chloride (C₂₇H₅₅N⁺(CH₃)₃Cl), heptacosyltrimethylammonium bromide (C₂₇H₅₅N⁺(CH₃)₃Br), and dioctadecyldimethylammonium chloride ((C₁₈H₃₇)₂N⁺(CH₃)₂Cl). Other examples of a salt of the non-polymeric dispersant represented by Formula (A1) include pentyltrimethylammonium chloride (8 carbon atoms in total), pentyltrimethylammonium bromide, hexyltrimethylammonium chloride (9 carbon atoms in total), hexyltrimethylammonium bromide, heptyltrimethylammonium chloride (10 carbon atoms in total), heptyltrimethylammonium bromide, octyltrimethylammonium chloride (11 carbon atoms in total), octyltrimethylammonium bromide, dibutyldimethylammonium chloride (10 carbon atoms in total), dibutyldimethylammonium bromide, dihexyldimethylammonium chloride (14 carbon atoms in total), dihexyldimethylammonium bromide, dioctyldimethylammonium chloride (18 carbon atoms in total), dioctyldimethylammonium bromide, didecyldimethylammonium chloride (22 carbon atoms in total), didecyldimethylammonium bromide, and octyldimethylethylammonium ethyl sulfate (12 carbon atoms in total).

Examples of the non-polymeric dispersant represented by Formula (A2) include a non-polymeric dispersant represented by Formula (A2-1) as follows:

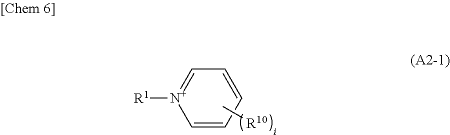

wherein in Formula (A2-1), R¹ and R¹⁰ each independently represents a hydrocarbon group optionally including a hetero atom (e.g., a nitrogen atom); i represents an integer of 0 to 5; and the total number of carbon atoms derived by combining hydrocarbon groups R¹ and R¹⁰ is 3 to 35 (e.g., 7 to 35).

Examples of a salt of the non-polymeric dispersant represented by Formula (A2) include dodecylpyridinium chloride (C₁₂H₂₅N⁺C₅H₅Cl), dodecylpyridinium bromide (C₁₂H₂₅N⁺C₅H₅Br), hexadecylpyridinium chloride (C₁₆H₃₃N⁺C₅H₅Cl), hexadecylpyridinium bromide (C₁₆Hd₃₃N⁺C₅H₅Br), and (1-hexadecyl-4-methylpyridinium chloride (C₁₆H₃₃N⁺C₅H₅(CH₃)Cl).

Examples of the non-polymeric dispersant represented by Formula (A3) include a non-polymeric dispersant represented by Formula (A3-1), (A3-2), or (A3-3) as follows:

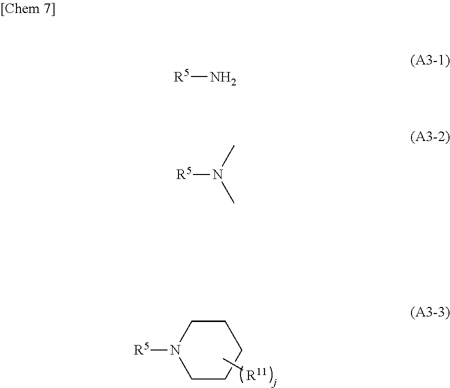

wherein in Formula (A3-2), R⁵ represents a hydrocarbon group optionally including a hetero atom (e.g., a nitrogen atom); and the number of carbon atoms in R⁵ is 6 to 38 (e.g., 7 to 35); and
wherein in Formula (A3-3), R⁵ and R¹¹ each independently represents a hydrocarbon group optionally including a hetero atom (e.g., a nitrogen atom); j represents an integer of 0 to 5; the total number of carbon atoms derived by combining hydrocarbon groups R⁵ and R¹¹ is 3 to 35 (e.g., 7 to 35).

Examples of the non-polymeric dispersant represented by Formula (A3) include dodecylamine (C₁₂H₂₅NH₂), dodecyldimethylamine (C₁₂H₂₅N(CH₃)₂), tridecylamine (C₁₃H₂₇NH₂), tetradecylamine (C₁₄H₂₉NH₂), pentadecylamine (C₁₅H₃₁NH₂), hexadecylamine (C₁₆H₃₃NH₂), hexadecyldimethylamine (C₁₆H₃₃N(CH₃)₂), heptadecylamine (C₁₇H₃₅NH₂), octadecylamine (C₁₈H₃₇NH₂), nonadecylamine (C₁₉H₃₉NH₂), icosylamine (C₂₀H₄₁NH₂), heneicosylamine (C₂₁H₄₃NH₂), docosylamine (C₂₂H₄₅NH₂), tricosylamine (C₂₃H₄₇NH₂), tetracosylamine (C₂₄H₄₉NH₂), pentacosylamine (C₂₅H₅₁NH₂), hexacosylamine (C₂₆H₅₃NH₂), heptacosylamine (C₂₇H₅₅NH₂), and N-dodecyl piperidine (C₁₂H₂₅NC₅H₁₀). Other examples of the non-polymeric dispersant represented by Formula (A3) include hexyldimethylamine, heptyldimethylamine, octylamine, octyldimethylamine, nonylamine, nonyldimethylamine, decylamine, decyldimethylamine, and undecylamine. Further examples of the non-polymeric dispersant represented by Formula (A3) include a non-polymeric dispersant in which at least one of R⁵, R⁶, and R⁷ is a hydrocarbon group including a hetero atom (e.g., a hydrocarbon group having an ether bond and/or a hydroxy group). A specific example of such a non-polymeric dispersant can be stearyl propylene glycol dimethylamine (C₁₈H₃₇OCH₂CH(OH)CH₂N(CH₃)₂).

Examples of the non-polymeric dispersant represented by Formula (A4) include a non-polymeric dispersant represented by Formula (A4-1) as follows:

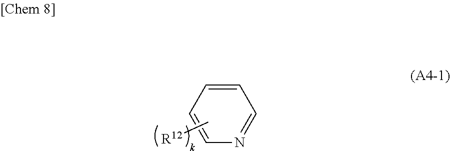

wherein in Formula (A4-1), each R¹² independently represents a hydrocarbon group optionally including a hetero atom (e.g., a nitrogen atom), k represents an integer of 0 to 5 (typically 1 to 5), and the total number of carbon atoms derived by combining hydrocarbon groups R¹² is 3 to 35 (e.g., 7 to 35).

Examples of the non-polymeric dispersant represented by Formula (A4) include 4-dodecylpyridine (C₁₂H₂₅NC₅H₅), 2-methyl-4-tridecylpyridine (C₁₃H₂₇NC₅H₄(CH₃)), 2-tetradecylpyridine (C₁₄H₂₉NC₅H₅), and 4-pentadecylpyridine (C₁₅H₃₁NC₅H₅).

Since the non-polymeric dispersant decreases relative to its additive amount in a process of producing the thermal insulating layer, the non-polymeric dispersant content in the thermal insulating layer can be considered as a residual amount. The non-polymeric dispersant content in the thermal insulating layer is not particularly limited. The non-polymeric dispersant content in the thermal insulating layer is typically more than 0% by mass, and may be, e.g., 0.0001% by mass or more, 0.0005% by mass or more, 0.001% by mass or more, or 0.05% by mass or more. The non-polymeric dispersant content in the thermal insulating layer may also be, e.g., 7% by mass or less, and is, in view of helping avoid an impact on another property, usually, suitably 5% by mass or less (e.g., 0.0001% by mass or more and 5% by mass or less). In some embodiments, the non-polymeric dispersant content in the thermal insulating layer is usually 0.01% by mass to 5% by mass, preferably 0.05% by mass or more, more preferably 0.1% by mass or more, even more preferably 0.2% by mass or more, and preferably 3% by mass or less, more preferably 2% by mass or less, even more preferably 1% by mass or less, particularly preferably 0.5% by mass or less, and may be 0.3% by mass or less, 0.1% by mass or less, 0.05% by mass or less, 0.01% by mass or less, 0.005% by mass or less, 0.001% by mass or less, or 0.0005% by mass or less. The non-polymeric dispersant content in the thermal insulating layer can be derived by extracting a non-polymeric dispersant from the thermal insulating layer using a suitable solvent (a solvent capable of dissolving a non-polymeric dispersant of interest), and performing quantitative analysis by a known technique. The type of a non-polymeric dispersant in the thermal insulating layer can be also known by extracting a non-polymeric dispersant from the thermal insulating layer with use of a suitable solvent, and identifying the non-polymeric dispersant in the extract liquid thus obtained by a known technique, in the same manner as described above.

The thermal insulating layer may contain another component as long as it is a layer containing the silicon dioxide particles, the inorganic fiber, and the non-polymeric dispersant as described above. In particular, the thermal insulating layer exemplarily contains a binder and/or inorganic particles other than silicon dioxide particles (hereinafter sometimes also omitted as “other inorganic particles”). When the thermal insulating material contains a binder, the type of the binder is not particularly limited, and specific examples thereof include thermoplastic resins, thermosetting resins, and sugars. The thermal insulating layer may contain one type of binder, or two or more types of binders. Inclusion of such a binder improves morphological stability.

When the thermal insulating layer contains a binder, the type of the binder is not particularly limited, and can be classified into organic binders and inorganic binders. Specific examples of the organic binders include thermoplastic resins, thermoplastic elastomers, thermosetting resins, thermosetting elastomers, sugars, and water-soluble polymers. Specific examples of the inorganic binders include aluminum oxide, zirconium oxide, magnesium oxide, titanium oxide, and calcium oxide. When the binder is one of these substances, the morphological stability is improved. The thermal insulating layer may contain one type of binder, or two or more types of binders.

When the thermal insulating layer contains a binder, the binder content is not particularly limited, and is usually 0.01% by mass to 10% by mass, preferably 0.05% by mass or more, more preferably 0.1% by mass or more, even more preferably 0.2% by mass or more, and preferably 5% by mass or less, more preferably 3% by mass or less, even more preferably 1% by mass or less. When the binder content falls within these ranges, the thermal insulating layer easily combines the thermal insulating property and the morphological stability. When the binder content falls within these ranges, it easily combines the thermal insulating property and the morphological stability.

When the thermal insulating layer contains other inorganic particles, the type of the other inorganic particles is not particularly limited, and examples thereof include zinc oxide, aluminum oxide, titanium oxide, silicon carbide, titanic iron ore (ilmenite, FeTiO), zirconium silicate, iron oxide (III) and iron oxide (II)(wustite(FeO), magnetite (Fe₃O₄), hematite (Fe₂O₃)), chromium dioxide, zirconium oxide, manganese dioxide, zirconia sol, titania sol, silica sol, alumina sol, bentonite, and kaolin. Carbon-based particles such as graphite, carbon black, and carbon powder can also be used as the aforementioned inorganic particles in the technologies disclosed herein. The graphite preferably have a particle diameter of 18 μm or less. The particle diameter of the graphite is measured in the same manner as for the average primary particle diameter of the silicon dioxide particles. When a manufacturer or the like provides a nominal value of a particle diameter, the nominal value may be employed. The type of the graphite for use can be any of flake, vein, spherical, and the like in shape. Examples of commercially available product of flake graphite include BF-3AK, FBF, and BF-10AK manufactured by Chuetsu Graphite Works Co., Ltd.; and GE-1, Z-5F, CNP7, and V-10F manufactured by Ito Graphite Co., Ltd. Examples of commercially products of vein graphite include HLP and SB-1 manufactured by Chuetsu Graphite Works Co., Ltd. Examples of commercially available products of spherical graphite include SG-BH8 manufactured by Ito Graphite Co., Ltd. Examples of commercially available products of carbon black include TOKABLACK #5500 manufactured by Tokai Carbon Co., Ltd. and MA100 manufactured by Mitsubishi Chemical Group Corporation. Without particular limitation, in some embodiments with use of carbon black as the inorganic particles, the carbon black for use may generally, preferably be a substance having relatively high DBP oil absorption in view of reducing thermal conductivity. The DBP oil absorption is suitably, e.g., 40 mL/100 g or more, and preferably 60 mL/100 g or more, or 80 mL/100 g or more. The thermal insulating layer may contain one type of inorganic particles, or two or more types of inorganic particles. In particular, the inorganic particles can preferably reduce thermal radiation, more particularly have an absorption peak within the infrared region. The absorption peak within the infrared region can be measured with an infrared spectrophotometer. The inorganic particles may also function as a binder that binds inorganic fiber fibrils one another.

The thermal insulating layer is a layer containing the silicon dioxide particles, the inorganic fiber, and the non-polymeric dispersant as described above, and is preferably a shaped material shaped from a mixture containing the silicon dioxide particles, the inorganic fiber, and the non-polymeric dispersant. Detailed description will be provided later for a method of mixing silicon dioxide particles, inorganic fiber, a non-polymeric dispersant, and the like in the case of the thermal insulating layer having a shaped material shaped from a mixture containing the silicon dioxide particles, the inorganic fiber, and the non-polymeric dispersant.

The thickness of the thermal insulating layer is not particularly limited, and is usually 0.5 mm to 10 mm, preferably 0.7 mm or more, more preferably 0.8 mm or more or 0.9 mm or more. In some embodiments, the thickness of the thermal insulating layer is preferably 1 mm or more, more preferably 1.5 mm or more, even more preferably 2 mm or more, and preferably 7 mm or less, more preferably 5 mm or less, even more preferably 3 mm or less. When the thermal insulating layer has a thickness within these ranges, a good thermal insulating property is likely to be ensured, and a need for the thermal insulating material to be larger can be eliminated. In some embodiments, the thickness of the thermal insulating layer may be less than 2 mm, less than 1.5 mm, 1.3 mm or less, 1 mm or less, or less than 1 mm. Providing the thermal insulating layer with a smaller thickness can make the thermal insulating material thinner or lighter. The thickness of the thermal insulating layer can exemplarily employ an average value of numerical values derived by measuring cross sections of the thermal insulating layer at several sites (e.g., 10 sites) with a thickness measuring instrument (e.g., the digital thickness gauge JAN-257 (gauge head: Φ20) manufactured by Ozaki Mfg. Co., Ltd.)

The density of the thermal insulating layer is not particularly limited, and is usually 0.2 g/cm³ to 0.5 g/cm³, preferably 0.3 g/cm³ or more, more preferably 0.35 g/cm³ or more, even more preferably 0.37 g/cm³ or more, and preferably 0.45 g/cm³ or less.

The thermal conductivity of the thermal insulating layer under a pressurized condition of 2 MPa at 80° C. is preferably 0.010 W/K·m or more, and preferably 0.3 W/K·m or less, more preferably 0.1 W/K·m or less, more preferably 0.08 W/K·m or less, more preferably 0.06 W/K·m or less, more preferably 0.055 W/K·m or less, more preferably 0.045 W/K·m or less, even more preferably 0.04 W/K·m or less. The thermal conductivity of the thermal insulating layer under a pressurized condition of 2 MPa at 600° C. is preferably 0.010 W/K·m or more, and preferably 0.3 W/K·m or less, more preferably 0.2 W/K·m or less, more preferably 0.1 W/K·m or less, more preferably 0.08 W/K·m or less, even more preferably 0.075 W/K·m or less.

When the thermal insulating layer is prepared so as to have a thickness of 2 mm without pressurization, the thermal resistance of the thermal insulating layer under a pressurized condition of 2 MPa at 80° C. is preferably 0.020 (K·m²)/W or more, more preferably 0.025 (K·m²)/W or more, more preferably 0.03 (K·m²)/W or more, even more preferably 0.035 (K·m²)/W or more, and preferably 0.1 (K·m²)/W or less. When the thermal insulating layer has an initial thickness of 2 mm, the thermal resistance of the thermal insulating layer under a pressurized condition of 2 MPa at 600° C. is preferably 0.010 (K·m²)/W or more, more preferably 0.015 (K·m²)/W or more, even more preferably 0.020 (K·m²)/W or more, and preferably 0.1 (K·m²)/W or less.

The thermal conductivity of the thermal insulating layer can be measured by the method described in Japanese Industrial Standards JIS A 1412-2: 1999, “Test Method for Thermal Resistance and Related Properties of Thermal Insulations—Part 2: Heat Flow Apparatus”.

The heat flow apparatus method (HFM method) is a secondary or comparative measurement method to measure heat-transfer properties, such as thermal conductivity and thermal resistance, by comparing a plane heat-insulating material (thermal insulating layer) of a sample and a standard plate. A procedure and conditions for the measurement will be described in detail as follows.

The thermal insulating layer is cut into a predetermined size (e.g., 20 mm×20 mm) as a sample, and a standard plate is prepared such as an alumina composite material (“RS-100” manufactured by ZIRCAR Refractory Composites, Inc.; thickness: 5 mm; thermal conductivity: 0.66 W/K·m). Subsequently, a first thermocouple, a titanium plate, the thermal insulating layer, a titanium plate, a second thermocouple, a standard plate, and a third thermocouple are stacked in this order from the top onto a surface of a lower disc of a pneumatic press, and the sample, the standard plate, the thermocouples, and the like are closely attached to one another between an upper disc and the lower disc. The upper disc and the lower disc are then heated at respective predetermined measurement temperatures, and a load is applied to pressurize the sample and the like to provide a predetermined measurement pressure using a pneumatic press.

The measurement temperature is exemplarily set to keep a temperature of 80° C. at an upper disc close to the first thermocouple, and a temperature of 30° C. at a lower disc close to the third thermocouple. Under a high-temperature condition, the measurement temperature is exemplarily set to keep a temperature of 600° C. at an upper disc close to the first thermocouple, and a temperature of 40° C. at a lower disc close to the third thermocouple.

The measurement pressure is exemplarily set to 2 MPa (load: 800 N). Measurement is continued under heating and pressurization until a detection temperature of each of the thermocouples is stable, and the thermal conductivity k1 of the thermal insulating layer can be calculated from the detection temperature of each of the thermocouples after stabilization of the temperature, the thickness of the thermal insulating layer at pressurization, the thermal conductivity of the standard plate, and the thickness of the standard plate at pressurization, according to Formula (1) as follows:

$$k 1 = k 2 \times ( L 1 \times Δ T 1 ) / ( L 2 \times Δ T 2 ) \qquad ( I )$$

wherein k1 is the thermal conductivity [W/(m·K)]of the thermal insulating layer, k2 is the thermal conductivity [W/(m·K)]of the standard plate, L1 is the pressurized thickness of the thermal insulating layer, L2 is the thickness of the standard plate, ΔT1 is temperature differential between the temperature of the second thermocouple and the temperature of the third thermocouple, and ΔT2 is temperature differential between the temperature of the first thermocouple and the temperature of the second thermocouple.

Stability of detection temperature exemplarily means that change in temperature between before and after a duration of 10 minutes falls within a predetermined range (e.g., within A0.1° C.).

The thermal resistance of the thermal insulating layer can be calculated from the thermal conductivity k1 and the pressurized thickness L1 described above, according to Formula (II) as follows:

$$R 1 = L 1 / k 1 \qquad ( II )$$

wherein R1 is the thermal resistance [(m²·K)/W]of the thermal insulating layer, k1 is the thermal conductivity [W/(m·K)]of the thermal insulating layer, and L1 is the pressurized thickness of the thermal insulating layer.

A compression property of the thermal insulating layer is not particularly limited, and can be considered by separating a thermal insulating layer having a high density with a density of 300 kg/m³ or more, and a thermal insulating layer having a low density with a density of less than 300 kg/³.

When the thermal insulating layer is a thermal insulating layer having a high density with a density of 300 kg/m³ or more, the compressive stress (a numerical value [MPa]derived by dividing a compression force [N]by the initial cross-sectional area of the sample) at a compressive strain of 25% is usually 1 MPa to 5 MPa, preferably 1.3 MPa or more, more preferably 1.7 MPa or more, even more preferably 2.0 MPa or more, and preferably 4.5 MPa or less, more preferably 4.0 MPa or less, even more preferably 3.5 MPa or less. A method of measuring the compressive stress is exemplarily a measurement process by the same method as for the cushioning layer described later.

When the thermal insulating layer is a thermal insulating layer having a high density with a density of 300 kg/m³ or more, the compressive stress at a compressive strain of 50% is usually 4.0 MPa to 15 MPa, preferably 5.0 MPa or more, more preferably 6.0 MPa or more, even more preferably 7.0 MPa or more, and preferably 13 MPa or less, more preferably 11 MPa or less, even more preferably 9.0 MPa or less.

When the thermal insulating layer is a thermal insulating layer having a high density with a density of 300 kg/m³ or more, the compressive stress at a compressive strain of 70% is usually 10 MPa to 25 MPa, preferably 11 MPa or more, more preferably 12 MPa or more, even more preferably 13 MPa or more, and preferably 23 MPa or less, more preferably 21 MPa or less, even more preferably 19 MPa or less.

When the thermal insulating layer is a thermal insulating layer having a low density with a density of less than 300 kg/m³, the compressive stress at a compressive strain of 25% is usually 0.05 MPa to 1.0 MPa, preferably 0.1 MPa or more, more preferably 0.15 MPa or more, even more preferably 0.20 MPa or more, and preferably 0.7 MPa or less, more preferably 0.5 MPa or less, even more preferably 0.3 MPa or less.

When the thermal insulating layer is a thermal insulating layer having a low density with a density of less than 300 kg/m³, the compressive stress at a compressive strain of 50% is usually 1.0 MPa to 4.0 MPa, preferably 1.3 MPa or more, more preferably 1.5 MPa or more, even more preferably 1.7 MPa or more, and preferably 3.5 MPa or less, more preferably 3.0 MPa or less, even more preferably 2.5 MPa or less.

When the thermal insulating layer is a thermal insulating layer having a low density with a density of less than 300 kg/m³, the compressive stress at a compressive strain of 70% is usually 4.0 MPa to 10 MPa, preferably 4.5 MPa or more, more preferably 5.0 MPa or more, even more preferably 5.5 MPa or more, and preferably 9.0 MPa or less, more preferably 8.0 MPa or less, even more preferably 7.0 MPa or less.

The number of the thermal insulating layers is usually 1 or more, and usually 10 or less, preferably 7 or less, even more preferably 5 or less.

The thermal insulating layer may or may not be bonded to an adjacent layer with an adhesive or a pressure-sensitive adhesive (PSA), and is preferably unbonded with an adhesive or a PSA. Absence of bonding with an adhesive or a PSA, i.e., use of neither an adhesive nor a PSA, allows reduction in thermal conductivity as compared to use thereof.

The shape of the thermal insulating layer is not particularly limited. In planar view, the shape is exemplarily, usually a rectangle (e.g., a polygon such as a tetragon), a circle, an oval, or the like.

### (Covering Layer)

The covering layer is a layer that is formed of a resin film and serves to prevent release of silicon dioxide particles in the thermal insulating layer, to protect the thermal insulating layer, and the like.

The type of resin in the covering layer is not particularly limited, and specific example thereof include polyethylene terephthalate (PET), polybutylene terephthalate (PBT), polyimide (PI), flameproof polycarbonate (PC), breathable porous polyethylene (PE) with a molecular weight of 1,000,000 to 7,000,000, flameproof polyethylene (PE), and biaxially oriented nylon film (Ny).

The thickness of the covering layer is not particularly limited, and is usually 0.001 mm to 0.2 mm, preferably 0.005 mm or more, more preferably 0.007 mm or more, even more preferably 0.010 mm or more, and preferably 0.15 mm or less, more preferably 0.10 mm or less, even more preferably 0.050 mm or less. When the covering layer has a thickness within these ranges, low thermal conductivity and mechanical strength can be combined. Measurement of the thickness of the covering layer can be performed in the same manner as for the thermal insulating layer.

The number the covering layers is usually 1 or more, preferably 2 or more, and usually 5 or less, preferably 4 or less, even more preferably 3 or less. The covering layer may be formed of a single resin film that is folded and inserted among the thermal insulating layer, a cushioning layer, and the like to provide a bilayer covering layer. In folding in such a way, the number of the covering layers is considered as two layers.

When the thermal insulating material includes two or more covering layers forming a stack, the two or more covering layers may sandwich and enclose the thermal insulating layer among themselves in a thickness direction, and seal a gap between the covering layers. A method of sealing a gap between the covering layers is not particularly limited, and an example thereof is usually a process of providing sealing parts on the outer edges of the covering layers and attaching the sealing parts of the covering layers to one another. A method of attaching the sealing parts is also not particularly limited, and examples thereof include fusion with use of heat fusion, ultrasonic fusion, or the like, and gluing with use of an adhesive, a PSA, or the like. Fusion may be performed by directly fusing resins of the covering layers, or fusing them by providing another resin layer for fusion.

The covering layer may or may not be bonded to an adjacent thermal insulating layer with an adhesive or a PSA, and is preferably unbonded with an adhesive or a PSA.

When the thermal insulating material includes two or more covering layers forming a stack that seal a gap between the covering layers, the covering layers preferably have a vent hole to connect the gap and an exterior space. Presence of the vent hole enables employing shrink packing or packing with use of a deep-drawing film as a packing method.

The number of vent holes in the covering layer is usually 1 or more, preferably 2 or more, and usually 50 or less, preferably 25 or less, even more preferably 10 or less.

The total opening area of vent holes in the covering layer is usually 0.000079 cm² to 10 cm², preferably 0.0001 cm² or more, more preferably 0.005 cm² or more, even more preferably 0.01 cm² or more, and preferably 5 cm² or less, more preferably 4 cm² or less, even more preferably 3 cm² or less. When the covering layer has a total opening area of vent holes within these ranges, the covering layer can reduce outflow of powder from the thermal insulating layer.

A vent hole in the covering layer may be covered with a venting film. The ventilation rate of the venting film is usually 4 cm³/(cm²·s) to 500 cm³/(cm²·s), preferably 7 cm³/(cm²·s) or more, more preferably 10 cm³/(cm²·s) or more, even more preferably 21 cm³/(cm²·s) or more, and preferably 250 cm³/(cm²·s) or less, more preferably 200 cm³/(cm²·s) or less, even more preferably 100 cm³/(cm²·s) or less.

The thermal insulating material may include a layer other than the thermal insulating layer and the covering layer as described above, and exemplarily include a cushioning layer that serves to compensate a physical property or the like that is poorly provided by only the thermal insulating layer. The cushioning layer will be described in detail below.

The compressive elastic modulus (yield point stress/strain) of the cushioning layer is usually 0.5 MPa to 20 MPa, preferably 0.7 MPa or more, more preferably 0.9 MPa or more, even more preferably 1.1 MPa or more, and preferably 18 MPa or less, more preferably 16 MPa or less, even more preferably 14 MPa or less.

A compression property of the cushioning layer is not particularly limited. When the cushioning layer has a compressive strain of 25%, the compressive stress is usually 0.1 MPa to 4 MPa, preferably 0.2 MPa or more, more preferably 0.3 MPa or more, even more preferably 0.4 MPa or more, and preferably 3.7 MPa or less, more preferably 3.5 MPa or less, even more preferably 3.3 MPa or less.

When the cushioning layer has a compressive strain of 50%, the compressive stress is usually 0.3 MPa to 7 MPa, preferably 0.5 MPa or more, more preferably 0.6 MPa or more, even more preferably 0.7 MPa or more, and preferably 6.5 MPa or less, more preferably 6.0 MPa or less, even more preferably 5.5 MPa or less.

When the cushioning layer has a compressive strain of 70%, the compressive stress is usually 2 MPa to 15 MPa, preferably 2.3 MPa or more, more preferably 2.5 MPa or more, even more preferably 2.7 MPa or more, and preferably 14 MPa or less, more preferably 12 MPa or less, even more preferably 10 MPa or less.

The compressive stress and the compressive elastic modulus (yield point stress/strain) of the cushioning layer can be measured with use of a precision universal testing machine AUTOGRAPH or the like. In particular, calculation can be made by cutting the cushioning layer into a predetermined size to provide a sample (a cross-sectional area parallel to a plane perpendicular to a compression direction is defined as a cross-sectional area to be used for calculating compressive stress), and measuring a compressive stress and a displacement in compression of the sample at a predetermined compression rate (e.g., 0.5 m/min).

Examples of the cushioning layer include a cushioning layer formed of a fiber-containing shaped material containing fibers (hereinafter sometimes omitted as “fiber-containing shaped material”) or a foamed shaped material containing foam (hereinafter sometimes omitted as “foamed shaped material”).

The fiber-containing shaped material is a shaped material containing fiber, and the thermal insulating layer described above is also preferably a shaped material shaped from a mixture containing silicon dioxide particles, inorganic fiber, and anon-polymeric dispersant. Accordingly, when the thermal insulating layer is a shaped material, discrimination between this shaped material and the fiber-containing shaped material in the cushioning layer can be determined by presence or absence of silicon dioxide particles. In other words, determination can be made for a layer containing silicon dioxide particles as the thermal insulating layer, and a layer containing fiber and no silicon dioxide particle as the cushioning layer. The fiber-containing shaped material in the cushioning layer is preferably a shaped material containing fiber and no silicon dioxide particle.

The type of fiber in the fiber-containing shaped material is not particularly limited, and can be classified into inorganic fiber and organic fiber in the same manner as for the thermal insulating layer. Specific examples include inorganic fiber such as glass wool or rock wool, and felt made of cellulose fiber, polyester, polypropylene, or the like; preferred is inorganic fiber, and particularly preferred is glass wool. Glass wool is a cured material containing fiber and thermosetting resin in which fiber fibrils are bonded to one another with thermosetting resin, and also has an effect to improve compressive stress and exert a cushioning function. The fiber-containing shaped material may contain one type of fiber, or two or more types of fiber. The fiber may assemble in form of any of nonwoven fabric, textile, knit, and the like, and usually takes a form of nonwoven fabric.

The fiber content in the fiber-containing shaped material is not particularly limited, and is usually 50% by mass to 99% by mass, preferably 60% by mass or more, more preferably 70% by mass or more, even more preferably 80% by mass or more, and preferably 97% by mass or less, more preferably 95% by mass or less, even more preferably 93% by mass or less. When the fiber content falls within these ranges, the fiber-containing shaped material is likely to exert cushioning property.

The average fiber length of fibers in the fiber-containing shaped material is not particularly limited, and is usually 1 mm to 200 mm, preferably 5 mm or more, more preferably 10 mm or more, even more preferably 20 mm or more, and preferably 175 mm or less, more preferably 150 mm or less, even more preferably 125 mm or less. When the fibers have an average fiber length within these ranges, the cushioning property is likely to be exerted.

The average fiber diameter of fibers in the fiber-containing shaped material is not particularly limited, and is usually 3 μm to 13 μm, preferably 4 m or more, more preferably 4.5 m or more, even more preferably 5 μm or more, and preferably 10 μm or less, more preferably 9 μm or less, even more preferably 8 μm or less. When the fibers have an average fiber diameter within these ranges, the fiber-containing shaped material easily combines the cushioning property and low thermal conductivity.

The fiber-containing shaped material is a shaped material containing fibers, and preferably contains a binder in addition to fiber. The type of the binder in the fiber-containing shaped material is not particularly limited, and can be classified into organic binders and inorganic binders.

Specific examples of the organic binders include thermoplastic resins, thermoplastic elastomers, thermosetting resins, thermosetting elastomers, sugars, and water-soluble polymers. Specific examples of the inorganic binders include aluminum oxide, zirconium oxide, magnesium oxide, titanium oxide, and calcium oxide. When the binder is one of these substances, the morphological stability is improved. The thermal insulating layer may contain one type of binder, or two or more types of binders.

The binder content in the fiber-containing shaped material is not particularly limited, and is usually 1% by mass to 50% by mass, preferably 2% by mass or more, more preferably 5% by mass or more, even more preferably 7% by mass or more, and preferably 40% by mass or less, more preferably 30% by mass or less, even more preferably 20% by mass or less. When the binder content falls within these ranges, low thermal conductivity and a better cushioning property are provided.

The fiber-containing shaped material is a shaped material containing fibers, preferably a shaped material shaped from a mixture containing fiber and a binder, and no hydrophilic fumed silica. Examples of fiber to be used for the fiber-containing shaped material include a commercial product containing a thermosetting resin dispersed as a binder, and such fiber can be cut into a form of interest, compressed with heating, and thereby formed into a fiber-containing shaped material.

The foamed shaped material is a shaped material containing foam. The material of the foam is usually a resin such as a thermoplastic resin or a thermosetting resin, and the foam can be shaped by appropriately employing a known shaping method and a condition thereof.

The type of resin of foam in the foamed shaped material is not particularly limited, and specific examples thereof include foamed forms of polyolefin-based resins such as polyethylene and polypropylene; polyethylene terephthalate resins; polyvinyl chloride resins (PVCs); styrene-based resins such as polystyrene; polyurethane-based resins such as polyurethan resins; resol phenolic resins such as phenolic resins (PFs), melamine-based resins such as melamine resins (MFs); epoxy-based resins such as epoxy resins (EPs).

The structure of cells in the foamed shaped material may be independent cells or continuous cells, and can be appropriately selected corresponding to a physical property of interest and the like.

When the thermal insulating material contains the cushioning layer, the thickness of the cushioning layer is usually 0.5 mm to 10 mm, preferably 1 mm or more, more preferably 1.5 mm or more, even more preferably 2 mm or more, and preferably 7 mm or less, more preferably 6 mm or less, even more preferably 5 mm or less. When the cushioning layer has a thickness within these ranges, a stress generated by battery expansion can be appropriately alleviated. Measurement of the thickness of the cushioning layer is exemplarily performed by measuring the thickness of a cross-section of the cushioning layer with use of a thickness measuring device (the digital thickness gage JAN-257; gauge head: Φ20; manufactured by Ozaki Mfg. Co., Ltd.) in the same manner as for the thermal insulating layer, further performing this measurement at any ten sites, and employing the average value of the numerical values thus obtained.

The thermal conductivity of the cushioning layer is not particularly limited, and is, under a condition of 80° C. and 2 MPa, preferably 0.030 W/K·m or more, more preferably 0.040 W/K·m or more, even more preferably 0.050 W/K·m or more, and preferably 0.2 W/K·m or less, more preferably 0.15 W/K·m or less, even more preferably 0.1 W/K·m or less. The thermal conductivity of the cushioning layer under a condition of 600° C. and 2 MPa is preferably 0.04 W/K·m or more, more preferably 0.05 W/K·m or more, even more preferably 0.06 W/K·m or more, and preferably 0.30 W/K·m or less, more preferably 0.25 W/K·m or less, even more preferably 0.20 W/K·m or less. The thermal conductivity can be measured by the same method as the method of measuring thermal conductivity of the thermal insulating material as described later.

The thermal resistance of the cushioning layer is not particularly limited, and is, under a condition of 80° C. and 2 MPa, preferably 0.020 (K·m²)/W or more, more preferably 0.025 (K·m²)/W or more, even more preferably 0.03 (K·m²)/W or more, and preferably 0.07 (K·m²)/W or less, more preferably 0.06 (K·m²)/W or less, even more preferably 0.05 (K·m²)/W or less. The thermal resistance of the thermal insulating layer under a condition of 600° C. and 2 MPa is preferably 0.001 (K·m²)/W or more, more preferably 0.003 (K·m²)/W or more, even more preferably 0.005 (K·m²)/W or more, and preferably 0.1 (K·m²)/W or less, more preferably 0.05 (K·m²)/W or less, even more preferably 0.01 (K·m²)/W or less. The thermal resistance can be measured by the same method as the method of measuring thermal resistance of the thermal insulating material as described later.

The number of the cushioning layers is usually 10 or less, preferably 5 or less, even more preferably 3 or less, and may be 2 or 1.

The cushioning layer may or may not be bonded to an adjacent layer with a PSA, and is preferably unbonded with an adhesive or a PSA. Absence of bonding with an adhesive or a PSA, i.e., use of neither an adhesive nor a PSA, allows reducing increase in thermal conductivity as compared to use thereof.

The shape of the cushioning layer is not particularly limited. In planar view, the shape is exemplarily, usually a rectangle (e.g., a polygon such as a tetragon), a circle, an oval, or the like.

In the thermal insulating material according to an embodiment of the present invention, another factor is not particularly limited as long as it meets the aforementioned conditions. Nevertheless, the thermal conductivity of the thermal insulating material under a condition of 80° C. and 2 MPa is preferably 0.02 W/K·m or more, more preferably 0.03 W/K·m or more, even more preferably 0.04 W/K·m or more, and preferably 0.2 W/K·m or less, more preferably 0.15 W/K·m or less, even more preferably 0.10 W/K·m or less. An exemplary method of measuring the thermal conductivity is measurement by the same method as for the thermal insulating layer.

When the thermal insulating material is prepared so as to have a thickness of 2 mm without pressurization, the thermal resistance of the thermal insulating material under a condition of 80° C. and 2 MPa is not particularly limited, and is preferably 0.01(K·m²)/W or more, more preferably 0.02(K·m²)/W or more, even more preferably 0.03(K·m²)/W or more, and preferably 0.10(K·m²)/W or less, more preferably 0.09(K·m²)/W or less, even more preferably 0.08(K·m²)/W or less. An exemplary method of measuring the thermal resistance is measurement by the same method as for the thermal insulating layer.

The thermal insulating material according to an embodiment of the present invention has no particular limitation in application and can be appropriately used for a known application with use of the thermal insulating material, but is particularly preferably used as the thermal insulating material provided between cells of a battery module, more specifically as the thermal insulating material provided between cells of a lithium ion battery module.

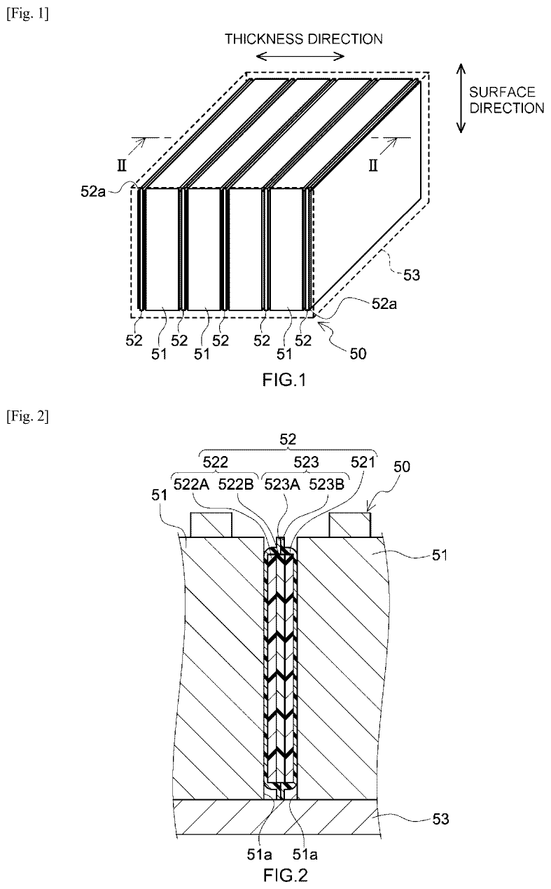

FIG. 1 is a perspective view schematically illustrating an exemplary battery module in which the thermal insulating material according to an embodiment is placed between cells, and FIG. 2 is a cross-sectional view thereof taken along the line II-II. As shown in FIG. 1, a battery module 50 includes a plurality of battery cells 51 (rectangular cells in the figures) arranged in a thickness direction, and the thermal insulating material 52 is placed between each couple of the battery cells 51. The plurality of the battery cells 51, arranged with holding the thermal insulating material 52 between each couple of themselves in this manner, is usually used with being constrained under application of suppress strength (compression force) in a thickness direction via constraint plates 52a and 52a placed on both ends and contained in a battery case 53.

As shown in FIG. 2, the thermal insulating material 52 has a configuration in which a thermal insulating layer 521 and cushioning layers 522 are stacked and further sandwiched between and enclosed with two resin films (a bilayer covering layer) 523A and 523B in a thickness direction. The resin films 523A and 523B are sealed by adhesion (e.g., heat fusion) at sealing parts provided along outer edges of the films, and combine together to form a covering material 523. Having such a configuration, the thermal insulating material 52 is inserted between neighboring two battery cells 51 and 51, thereby exerting an effect to provide thermal insulating between opposed faces 51a and 51a on the two battery cells 51 and 51. FIG. 2 depicts a configuration in which two cushioning layers 522A and 522B are stacked and arranged within the covering material 523, but the number of cushioning layers may be one or two or more, and two or more cushioning layers may be placed separately on both side of a thermal insulating layer. Likewise, FIG. 2 depicts a configuration including only one thermal insulating layer 521, but the number of thermal insulating layers may be two or more. A cushioning layer may be placed outside a covering material, and a plurality of cushioning layers may be placed separately inside and outside a covering material. The covering material 523 may include a vent hole.

Some possible embodiments of the thermal insulating material will be illustrated in more detail.

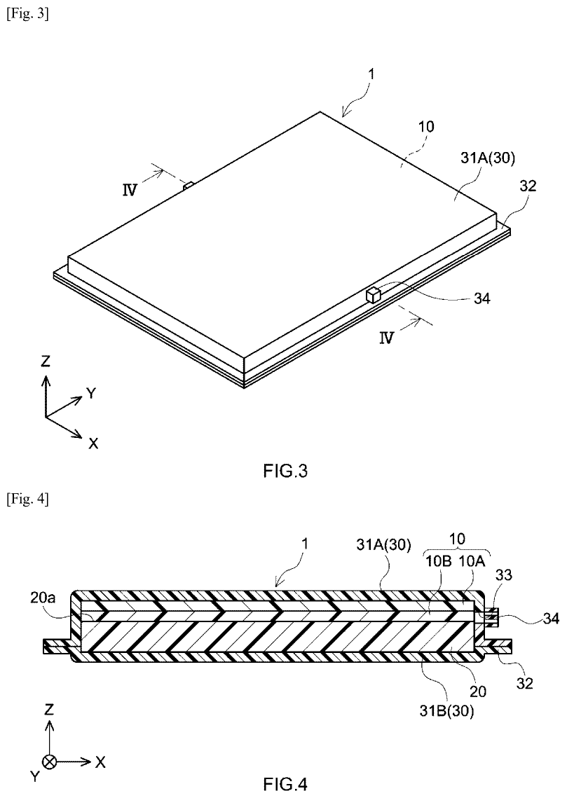

FIG. 3 is a perspective view schematically illustrating a thermal insulating material according to an embodiment and FIG. 4 is a cross-sectional view taken along the line IV-IV in FIG. 3. A thermal insulating material 1 has a configuration in which a thermal insulating layer 10 formed of two thermal insulating layers 10A and 10B is placed on one face 20a of a cushioning layer 20 to form a stack that is sandwiched between and enclosed with two resin films 31A and 31B (a bilayer covering layer) in a thickness direction, as shown in FIG. 4. The resin films 31A and 31B are sealed by adhesion (e.g., heat fusion) at sealing parts 32 provided along the outer edge of the films, and combine together to form a covering material 30. The resin film 31A is shaped into a protrusion form largely covering an end face of a stack of the thermal insulating layer 10 and the cushioning layer 20, and a vent hole (through hole) 33 is formed on a part covering the end face. An opening of the vent hole 33 to the outside includes a venting film 34 for preventing outflow of powder from the thermal insulating layer. When the thermal insulating material 1 is placed, e.g., between cells in a battery module including a plurality of cells arranged in a thickness direction, the thermal insulating material 1 may be used with being placed in such a manner that the Z-direction depicted in FIG. 4 (a thickness direction of the thermal insulating material 1) is a direction of arrangement of the cells, and that the Y-direction is a direction for removing an electrode of each of the cells, i.e., in such a manner that that a direction of an opening of a vent hole in the thermal insulating material 1 (X-direction) is not identical with a direction for removing an electrode of each of the cells.

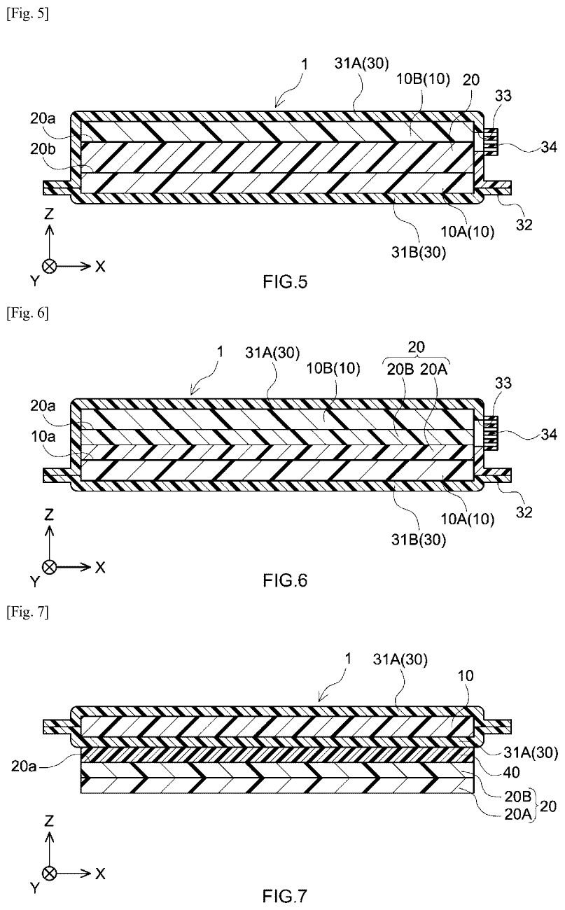

FIG. 5 is a cross-sectional view schematically illustrating a thermal insulating material according to another embodiment. In this embodiment two thermal insulating layers 10A and 10B forming a thermal insulating layer 10 are stacked separately on a first face 20a and a second face 20b of a cushioning layer 20. Having such a configuration, the thermal insulating material 1 has high structural symmetry along a thickness direction, also facilitates reducing difference in temperature between both faces, and thus can be advantageous in view of preventing deformation (e.g., warp deformation) of the thermal insulating material. In addition, as seen in the exemplary embodiment shown in FIG. 6, the cushioning layer 20 may have a stack structure formed of two layers of cushioning layers 20A and 20B, or a stack structure formed of three or more layers. An inner face 10a of the thermal insulating layer 10A and a cushioning layer 20 may or may not be bonded. The same applies to bonding of an inner face of the thermal insulating layer 10B and the cushioning layer 20.

FIG. 7 is a cross-sectional view schematically illustrating a thermal insulating material according to another embodiment. In this embodiment while a thermal insulating layer 10 is enclosed with a covering material 30, a cushioning layer 20 is placed outside the covering material 30. In particular, one face 20a of the cushioning layer 20 is fixed to one face of the covering material 30 via an adhesive layer 40 formed of an adhesive or a PSA. The thermal insulating material disclosed herein can also be implemented in such an embodiment.

A cell of interest is not limited to a rectangular cell, and may be any of, e.g., a laminated cell and a cylindrical cell. The shape of the thermal insulating material can be appropriately employed corresponding to the type of a cell.

Examples of a device to be equipped with a battery include electric conveyances such as electric vehicles (EVs), hybrid vehicles (HVs), and plug-in hybrid vehicles (PHVs); mobile electronics such as mobile terminals, mobile phones, and laptop PCs; and wearable devices.

### (Production Method of Thermal Insulating Material)

A method of producing a thermal insulating material is not particularly limited, can be carried out by appropriately employing a known step, and is usually, e.g., a production method including the following steps:
Mixing step: a step of mixing silicon dioxide particles, inorganic fiber, and at least one kind of non-polymeric dispersant represented by Formula (A1), (A2), (A3), or (A4) as follows in a solvent to prepare a mixture liquid;
Applying step: a step of applying the mixture liquid prepared in the mixing step to provide an applied film; and
A step of shaping the applied film provided in the applying step to provide a thermal insulating layer.

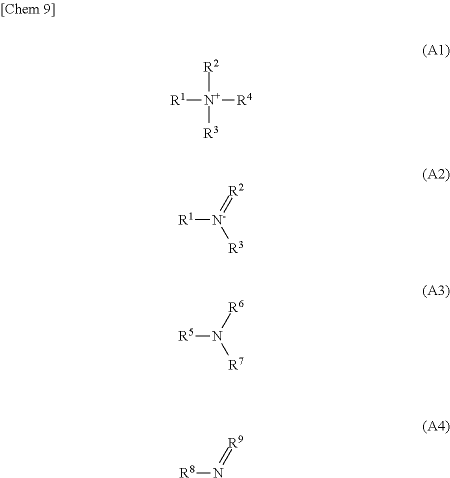

wherein, in Formulae (A1) and (A2), R¹, R², R³, and R⁴ each independently represents a hydrocarbon group optionally including a hetero atom; a total number of carbon atoms derived by combining hydrocarbon groups R¹, R², R³, and R⁴ is 8 to 40; and hydrocarbon groups R¹, R², R³, and R⁴ optionally bind to one another to form a cyclic structure;
wherein, in Formula (A3), R⁵ represents a hydrocarbon group optionally including a hetero atom; R⁶ and R⁷ each independently represents a hydrogen atom or a hydrocarbon group optionally including a hetero atom; a total number of carbon atoms derived by combining hydrocarbon groups R⁵, R⁶, and R⁷ is 8 to 40; and hydrocarbon groups R⁵, R⁶, and R⁷ optionally bind to one another to form a cyclic structure; and
wherein, in Formula (A4), R⁸ and R⁹ each independently represents a hydrocarbon group optionally including a hetero atom; a total number of carbon atoms derived by combining hydrocarbon groups R⁸ and R⁹ is 8 to 40; and hydrocarbon groups R⁸ and R⁹ optionally bind to one another to form a cyclic structure.

The mixing step, the applying step, the shaping step, and the like will be described in detail below.

The mixing step is a step of mixing silicon dioxide particles, inorganic fiber, and at least one kind of non-polymeric dispersant represented by Formula (A1), (A2), (A3), or (A4) in a solvent to provide a mixture liquid; this is a so-called wet process, particularly a step of mixing silicon dioxide particles, inorganic fiber, and a non-polymeric dispersant in a solvent to prepare a mixture liquid (a slurry form). Mixing in the mixing step uses, e.g., a dispersing propeller mixer, LABO PLASTOMILL, TRI-MIX, a planetary mixer, or a kneader.

The type of the solvent is not particularly limited, and examples thereof include protic solvents such as alcohol, amide, and water; and non-protic solvents such as ester, ketone, nitrile, and ether.

The surface tension of the solvent is not particularly limited, usually 20 mN/m to 73 mN/m, preferably 21 mN/m or more, preferably 50 mN/m or less, more preferably 40 mN/m or less, even more preferably 30 mN/m or less. When the solvent has a surface tension within these ranges, the thermal insulating property and the mechanical strength are better improved. An exemplary method of measuring the surface tension of the solvent is measurement by ring method.

The additive amount of the non-polymeric dispersant to be added to the mixture liquid in the mixing step is not particularly limited, and can be suitably set in consideration of combination of an effect of use with an impact on another property. The additive amount of the dispersant in the mixture liquid may be, e.g., 0.0001 parts by mass or more relative to 100 parts by mass of the additive amount of silicon dioxide particles in the mixture liquid; in view of facilitating providing a higher effect of use, the additive amount of the dispersant may be 0.0005 parts by mass or more, 0.001 parts by mass or more, or 0.05 parts by mass or more. The additive amount of the dispersant in the mixture liquid may also be, e.g., 10 parts by mass or less relative to 100 parts by mass of the additive amount of silicon dioxide particles in the mixture liquid; in view of facilitating eliminating an impact on another property, the additive amount of the dispersant is usually suitably 5 parts by mass or less (e.g., 0.0001 parts by mass or more and 5 parts by mass or less), advantageously 3 parts by mass or less, and may be 2 parts by mass or less, 1 part by mass or less, or less than 1 part by mass (e.g., 0.8 parts by mass or less). In some embodiments, the additive amount of the dispersant in the mixture liquid is usually 0.05 parts by mass to 5 parts by mass, preferably 0.1 parts by mass or more, more preferably 0.2 parts by mass or more, even more preferably 0.5 parts by mass or more, and preferably 2 parts by mass or less, relative to 100 parts by mass of the additive amount of silicon dioxide particles in the mixture liquid. When the additive amount of the non-polymeric dispersant falls within these ranges, the admixture liquid is dispersively stabilized, and the thermal insulating material has a good thermal insulating property.

Mixing temperature is not particularly limited, and is usually 20° C. or higher and not higher than a boiling point of the solvent, preferably 22° C. or more, preferably 50° C. or less, more preferably 40° C. or less, even more preferably 30° C. or less. When mixing temperature falls within these ranges, the solvent (e.g., organic solvent) is less volatile, leading to less change in a compounding ratio.

Mixing time is not particularly limited, and is usually 1 minute to 5 hours, preferably 5 minutes or more, preferably 4 hours or less, more preferably 2 hours or less, even more preferably 1 hour or less. When mixing time falls within these ranges, the thermal insulating material can be produced efficiently.

The consistency of the mixture liquid is not particularly limited, and is usually 50 to 200, preferably 55 or more, more preferably 60 or more, even more preferably 65 or more, and preferably 180 or less, more preferably 160 or less, even more preferably 140 or less. When the mixture liquid has a consistency within these ranges, breakage of fibers can be reduced in dispersing fibers homogenously.

An exemplary method of measuring the consistency of the mixture liquid is the method described in Japanese Industrial Standards JIS K 2220: 2013, “Lubricating Grease-Part 7: Test method for Cone Penetration”, particularly measurement as “unworked penetration”. A measuring device capable of measuring consistency is commercially available, and specific examples thereof include a penetrometer available from Nikka-engineering KK. A measuring procedure is as follows: a pot is prepared with such a large size that a cone weight is capable of descending without contact with the pot, and the pot is filled with the mixture liquid and placed on a measuring device equipped with the weight. Next, a position of the weight is adjusted and set so as to provide contact between the weight and the mixture liquid, and the position is defined as zero. Then, the weight is moved down for 5 seconds (±0.1 seconds) under a condition at room temperature (25° C.), and a depth of penetration of the weight into the mixture liquid (mm)×10 is calculated as a consistency. As the cone weight a standard cone defined in Japanese Industrial Standards is exemplarily used, and a weight with a total mass of 102.5 g±0.05 g and a weight holder having a mass of 47.5±0.05 g are exemplarily used.

An application method and an application condition in the applying step are not particularly limited, and can appropriately employ a known method, and examples thereof include application with a comma coater, a spin coater, a die coater, a roll coater, a calendar roll, a dispenser, or the like.

A shaping method and a shaping condition in the shaping step are not particularly limited, and can appropriately employ a known method, and examples thereof include a process of compress-shaping with, e.g., hot press or vacuum press so as to provide a density of 0.3 g/cm³ to 0.5 g/cm³, and drying with, e.g., a floating oven and/or an IR oven. As a drying condition, drying temperature is preferably, e.g., 60° C. to 150° C. Drying time is preferably, e.g., 4 minutes to 20 minutes.

As can be seen in the explanation described above and the examples described later, the items disclosed herein include the following.

[1]A thermal insulating material including a thermal insulating layer containing silicon dioxide particles having a BET specific surface area of 90 m²/g or more and less than 380 m²/g, inorganic fiber, and at least one kind of non-polymeric dispersant represented by Formula (A1), (A2), (A3), or (A4) as follows:

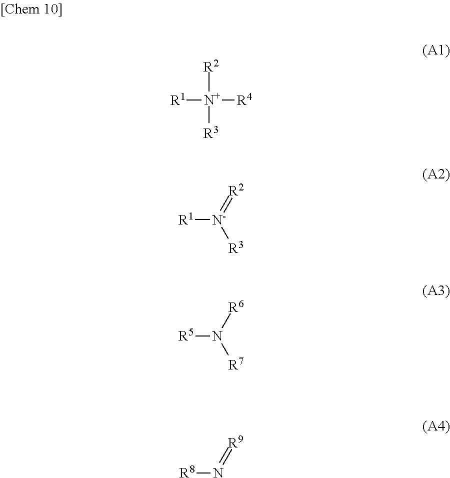

wherein, in Formulae (A1) and (A2), R¹, R², R³, and R⁴ each independently represents a hydrocarbon group optionally including a hetero atom; a total number of carbon atoms derived by combining hydrocarbon groups R¹, R², R³, and R⁴ is 8 to 40; and hydrocarbon groups R¹, R², R³, and R⁴ optionally bind to one another to form a cyclic structure;
wherein, in Formula (A3), R⁵ represents a hydrocarbon group optionally including a hetero atom; R6 and R⁷ each independently represents a hydrogen atom or a hydrocarbon group optionally including a hetero atom; a total number of carbon atoms derived by combining hydrocarbon groups R⁵, R⁶, and R⁷ is 8 to 40; and hydrocarbon groups R⁵, R6, and R⁷ optionally bind to one another to form a cyclic structure; and
wherein, in Formula (A4), R⁸ and R⁹ each independently represents a hydrocarbon group optionally including a hetero atom; a total number of carbon atoms derived by combining hydrocarbon groups R⁸ and R⁹ is 8 to 40; and hydrocarbon groups R⁸ and R⁹ optionally bind to one another to form a cyclic structure.

[2]A thermal insulating material including a thermal insulating layer containing silicon dioxide particles, inorganic fiber, and at least one kind of non-polymeric dispersant represented by Formula (A1), (A2), (A3), or (A4) as follows:

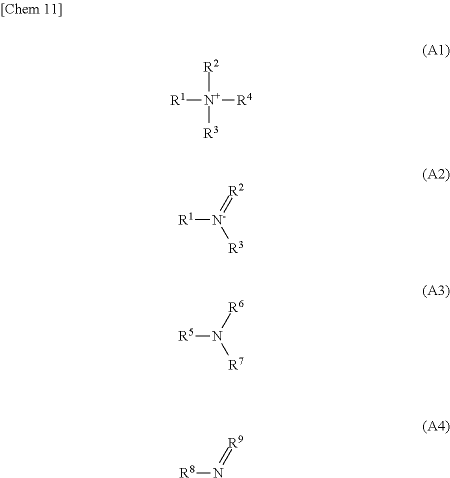

wherein, in Formulae (A1) and (A2), R¹, R², R³, and R⁴ each independently represents a hydrocarbon group optionally including a nitrogen atom; a total number of carbon atoms derived by combining hydrocarbon groups R¹, R², R³, and R⁴ is 12 to 40; and hydrocarbon groups R¹, R², R³, and R⁴ optionally bind to one another to form a cyclic structure;
wherein, in Formula (A3), R⁵ represents a hydrocarbon group optionally including a nitrogen atom; R⁶ and R⁷ each independently represents a hydrogen atom or a hydrocarbon group optionally including a nitrogen atom; a total number of carbon atoms derived by combining hydrocarbon groups R⁵, R⁶, and R⁷ is 12 to 40; and hydrocarbon groups R⁵, R⁶, and R⁷ optionally bind to one another to form a cyclic structure; and
wherein, in Formula (A4), R⁸ and R⁹ each independently represents a hydrocarbon group optionally including a nitrogen atom; a total number of carbon atoms derived by combining hydrocarbon groups R⁸ and R⁹ is 12 to 40; and hydrocarbon groups R⁸ and R⁹ optionally bind to one another to form a cyclic structure.

[3]The thermal insulating material set forth in the item [1]or [2], wherein the content of the non-polymeric dispersant in the thermal insulating layer is 0.01% by mass to 5% by mass.

[4]The thermal insulating material set forth in any of the items [1]to [3], wherein the silicon dioxide particles is at least one kind selected from the group consisting of dry silica, wet silica, and silica aerogel.

[5]The thermal insulating material set forth in any of the items [1]to [3], wherein the silicon dioxide particles is at least one kind selected from the group consisting of hydrophilic fumed silica and hydrophobic fumed silica.

[6]The thermal insulating material set forth in any of the items [1]to [5], wherein the silicon dioxide particles has an average primary particle diameter of 100 nm or less.

[7]The thermal insulating material set forth in any of the items [1]to [6], wherein the inorganic fiber is at least one kind selected from the group consisting of glass fiber and biosoluble inorganic fiber.

[8]The thermal insulating material set forth in any of the items [1]to [7], wherein the thermal insulating layer has a density of 0.2 g/cm³ to 0.5 g/cm³.

[9]The thermal insulating material set forth in any of the items [1]to [8], wherein the thermal insulating layer has a thermal conductivity of 0.045 W/(m·K) or less under a pressurized condition of 2 MPa at 80° C.

[10]The thermal insulating material set forth in any of the items [1]to [9], wherein the thermal insulating layer has a thermal conductivity of 0.08 W/(m·K) or less under a pressurized condition of 2 MPa at 600° C.

[11]The thermal insulating material set forth in any of the items [1]to [10], further including a covering layer formed of a resin film,
wherein the thermal insulating layer and the covering layer are stacked.

[12]The thermal insulating material set forth in the item [11],
wherein the thermal insulating material comprises two or more of the covering layers forming a stack, and
wherein the two or more covering layers sandwich and enclose the thermal insulating layer among themselves in a thickness direction, and seal a gap between the covering layers.

[13]The thermal insulating material set forth in the item [12], wherein the covering layer has a vent hole to connect the gap to an exterior space.

[14]The thermal insulating material set forth in any of the items [1]to [13], the thermal insulating material being placed between cells in a battery module.

[15]A method of producing a thermal insulating material including:
a mixing step of mixing silicon dioxide particles, inorganic fiber, and a non-polymeric dispersant represented by Formula (A1), (A2), (A3), or (A4) as follows in a solvent to prepare a mixture liquid,
an applying step of applying the mixture liquid prepared in the mixing step to provide an applied film, and
a shaping step of shaping the applied film provided in the applying step to provide a thermal insulating layer:

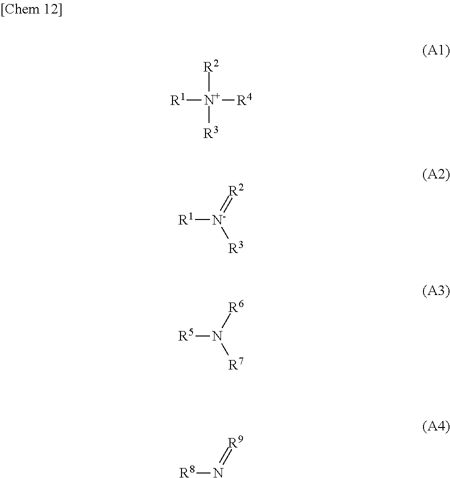

wherein, in Formulae (A1) and (A2), R¹, R², R³, and R⁴ each independently represents a hydrocarbon group optionally including a hetero atom; a total number of carbon atoms derived by combining hydrocarbon groups R¹, R², R³, and R⁴ is 8 to 40; and hydrocarbon groups R¹, R², R³, and R⁴ optionally bind to one another to form a cyclic structure;
wherein, in Formula (A3), R⁵ represents a hydrocarbon group optionally including a hetero atom; R⁶ and R⁷ each independently represents a hydrogen atom or a hydrocarbon group optionally including a hetero atom; a total number of carbon atoms derived by combining hydrocarbon groups R⁵, R⁶, and R⁷ is 8 to 40; and hydrocarbon groups R⁵, R⁶, and R⁷ optionally bind to one another to form a cyclic structure; and
wherein, in Formula (A4), R⁸ and R⁹ each independently represents a hydrocarbon group optionally including a hetero atom; a total number of carbon atoms derived by combining hydrocarbon groups R⁸ and R⁹ is 8 to 40; and hydrocarbon groups R⁸ and R⁹ optionally bind to one another to form a cyclic structure.

[16]A method of producing a thermal insulating material including:
a mixing step to mix silicon dioxide particles, inorganic fiber, and a non-polymeric dispersant represented by Formula (A1), (A2), (A3), or (A4) as follows in a solvent to prepare a mixture liquid,
an applying step to apply the mixture liquid prepared in the mixing step to provide an applied film, and
a shaping step to shape the applied film provided in the applying step to provide a thermal insulating layer:

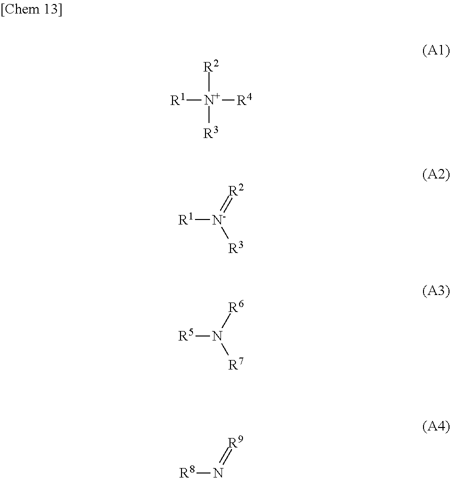

wherein, in Formulae (A1) and (A2), R¹, R², R³, and R⁴ each independently represents a hydrocarbon group optionally including a nitrogen atom; a total number of carbon atoms derived by combining hydrocarbon groups R¹, R², R³, and R⁴ is 12 to 40; and hydrocarbon groups R¹, R², R³, and R⁴ optionally bind to one another to form a cyclic structure;
wherein, in Formula (A3), R⁵ represents a hydrocarbon group optionally including a nitrogen atom; R⁶ and R⁷ each independently represents a hydrogen atom or a hydrocarbon group optionally including a nitrogen atom; a total number of carbon atoms derived by combining hydrocarbon groups R⁵, R⁶, and R⁷ is 12 to 40; and hydrocarbon groups R⁵, R⁶, and R⁷ optionally bind to one another to form a cyclic structure; and
wherein, in Formula (A4), R⁸ and R⁹ each independently represents a hydrocarbon group optionally including a nitrogen atom; a total number of carbon atoms derived by combining hydrocarbon groups R⁸ and R⁹ is 12 to 40; and hydrocarbon groups R⁸ and R⁹ optionally bind to one another to form a cyclic structure.

[17]The method of producing a thermal insulating material set forth in any of the items [15]to [16], wherein the non-polymeric dispersant is added to the mixture liquid in an amount of 0.05 parts by mass to 5 parts by mass relative to 100 parts by mass of the silicon dioxide particles.

[18]The method of producing a thermal insulating material set forth in any of the items [15]to [17], wherein the solvent is a protic solvent.

[19]The method of producing a thermal insulating material set forth in any of the items [15]to [18], wherein the solvent has a surface tension of less than 73 mN/m.

### EXAMPLE

### <<Experimental Example 1>>

### <Production of Thermal Insulating Material (Thermal Insulating Layer)>

### Example 1

To a mixture solvent (surface tension: 23 mN/m) of 300 parts by mass of isopropyl alcohol (IPA, surface tension: 21 mN/m) and 60 parts by mass of water (surface tension: 73 mN/m) as protic solvents is added 100 parts by mass of hydrophilic fumed silica (“AEROSIL® 200” manufactured by Nippon Aerosil Co., Ltd.; average primary particle diameter: about 12 nm; BET specific surface area: 200 m²/g), 20 parts by mass of glass fiber (“CS 6J-888” manufactured by Nitto Boseki Co., Ltd.; average fiber length: 6 mm; average fiber diameter: 11 μm) as inorganic fiber, and 1.9 parts by mass of “QUARTAMIN 24P” manufactured by Kao Corporation (active ingredient: dodecyltrimethylammonium chloride (C₁₂H₂₅N⁺(CH₃)₃Cl); active ingredient content: 27% by mass) (0.5 parts by mass of an active ingredient (ammonium salt)) as a dispersant containing a non-polymeric dispersant, and mixed so as to have a consistency of 70 to 140. Note that the dispersant contains a solvent (dispersion medium) such as water as the rest, in addition to a non-polymeric dispersant as an active ingredient. The term “active ingredient” in this example and each of the following examples refers to a non-polymeric or polymeric dispersant component, a surfactant component, or the like in the dispersant product used in each example. The mixture liquid thus obtained was assessed for consistency measurement and dispersive stability as described later. Next, the mixture liquid thus obtained was applied onto a substrate so as to provide a thickness of 2 mm to form an applied film. The applied film was further compress-shaped with a hot press machine so as to form a sheet with a thickness of 1 mm and a density of 0.3 g/cm³ to 0.5 g/cm³, and dried at 100° C. for 10 minutes, thereby producing a thermal insulating material (thermal insulating layer) that is a shaped material shaped from a mixture containing hydrophilic fumed silica, glass fiber, and anon-polymeric dispersant. The thermal insulating material (thermal insulating layer) thus obtained had a thickness of 1 mm and a density of 0.37 g/cm³.

Next, the content of dodecyltrimethylammonium chloride in the thermal insulating material (thermal insulating layer) thus obtained was measured by high-performance liquid chromatography-mass spectrometry (LC/MS). First, standard solutions with a plurality of concentrations of QUARTAMIN 24P dissolved were prepared, and a calibration curve was created for concentrations of dodecyltrimethylammonium chloride to area values of the LC/MS. Then, 0.05 g of the thermal insulating material was taken, added to 25 mL of a 1:1 (volume ratio) mixture liquid of ultrapure water/ethanol and agitated for 1 or more hours, thereby extracting dodecyltrimethylammonium chloride contained in the thermal insulating material. The solution thus obtained was passed through a membrane filter (0.20 μm) and loaded in the LC/MS, and the content of dodecyltrimethylammonium chloride in the solution was measured from the calibration curve described above. The dodecyltrimethylammonium chloride content in the thermal insulating material was calculated from the dodecyltrimethylammonium chloride content in 0.05 g of the thermal insulating material, and consequently revealed as 0.31% by mass.

Conditions of the LC/MS measurement were as follows:
Measuring device: high-performance liquid chromatograph-mass spectrometer (UltiMate3000/TSQ QUANTUM ACCESS MAX, manufactured by Thermo Fisher Scientific Co., Ltd.)
Column: “L-column 3 C18” manufactured by Chemical Evaluation and Research Institute, Japan
Eluent composition: pure water (ammonium acetate added)/acetonitrile-based gradient
Flow rate: 0.6 mL/min
Detector: MS (full scan: 100 to 500, m/z=228)
Column temperature: 40° C.
Injection volume: 5 μL
Ionization: ESI (POS.)
Ion spraying voltage: 3.0 kV
Evaporation temperature: 350° C.
Capillary temperature: 270° C.

### Example 2

Athermal insulating material having a thickness of 1 mm was prepared by the same method as in Example 1 except for changing the additive amount of QUARTAMIN 24P so as to provide dodecyltrimethylammonium chloride, which is a non-polymeric dispersant in Example 1, in an amount of 0.05 parts by mass relative to 100 parts by mass of hydrophilic fumed silica.

### Example 3

Athermal insulating material having a thickness of 1 mm was prepared by the same method as in Example 1 except for changing the additive amount of QUARTAMIN 24P so as to provide dodecyltrimethylammonium chloride, which is a non-polymeric dispersant in Example 1, in an amount of 1 part by mass relative to 100 parts by mass of hydrophilic fumed silica.

### Example 4

A thermal insulating material having a thickness of 1 mm was prepared by the same method as in Example 1 except for changing the additive amount of QUARTAMIN 24P so as to provide dodecyltrimethylammonium chloride, which is a non-polymeric dispersant in Example 1, in an amount of 2 parts by mass relative to 100 parts by mass of hydrophilic fumed silica.

### Example 5

A thermal insulating material having a thickness of 1 mm was prepared by the same method as in Example 1 except for changing the additive amount of QUARTAMIN 24P so as to provide dodecyltrimethylammonium chloride, which is a non-polymeric dispersant in Example 1, in an amount of 3 parts by mass relative to 100 parts by mass of hydrophilic fumed silica.

### Example 6

A thermal insulating material having a thickness of 1 mm was prepared by the same method as in Example 1 except for changing the additive amount of QUARTAMIN 24P so as to provide dodecyltrimethylammonium chloride, which is a non-polymeric dispersant in Example 1, in an amount of 5 parts by mass relative to 100 parts by mass of hydrophilic fumed silica.

### Example 7

A thermal insulating material having a thickness of 1 mm was prepared by the same method as in Example 1 except for changing dodecyltrimethylammonium chloride, which is a non-polymeric dispersant in Example 1, to hexadecyl (C16)trimethylammonium chloride (“QUARTAMIN 60W” manufactured by Kao Corporation; 0.5 parts by mass of an active ingredient (ammonium salt)).

### Example 8

A thermal insulating material having a thickness of 1 mm was prepared by the same method as in Example 1 except for changing dodecyltrimethylammonium chloride, which is a non-polymeric dispersant in Example 1, to octadecyl (C18)trimethylammonium chloride (“QUARTAMIN 86W” manufactured by Kao Corporation; 0.5 parts by mass of an active ingredient (ammonium salt)).

### Example 9

A thermal insulating material having a thickness of 1 mm was prepared by the same method as in Example 1 except for changing dodecyltrimethylammonium chloride, which is a non-polymeric dispersant in Example 1, to docosyl (C22)trimethylammonium chloride (“LIPOQUAD 22-80” manufactured by Lion Specialty Chemicals Co., Ltd.; 0.5 parts by mass of an active ingredient (ammonium salt)).

### Example 10

Athermal insulating material having a thickness of 1 mm was prepared by the same method as in Example 1 except for changing dodecyltrimethylammonium chloride, which is a non-polymeric dispersant in Example 1, to dodecyl (C12)ethyldimethylammonium ethyl sulfate (“CATIOGEN ES-L” manufactured by DKS Co., Ltd.; 0.5 parts by mass of an active ingredient (ammonium ethyl sulfate)).

### Example 11

Athermal insulating material having a thickness of 1 mm was prepared by the same method as in Example 1 except for changing dodecyltrimethylammonium chloride, which is a non-polymeric dispersant in Example 1, to dodecyl (C12)benzylmethylammonium chloride (“CATIOGEN BC-50” manufactured by DKS Co., Ltd.; 0.5 parts by mass of an active ingredient (ammonium salt)).

### Example 12

Athermal insulating material having a thickness of 1 mm was prepared by the same method as in Example 1 except for changing dodecyltrimethylammonium chloride, which is a non-polymeric dispersant in Example 1, to dodecyl (C12)amine (“LIPOMIN 12D” manufactured by Lion Specialty Chemicals Co., Ltd.; 0.5 parts by mass of an active ingredient (amine)).

### Example 13

Athermal insulating material having a thickness of 1 mm was prepared by the same method as in Example 1 except for changing dodecyltrimethylammonium chloride, which is a non-polymeric dispersant in Example 1, to dodecyl (C12)dimethylamine (“LIPOMIN DM12D” manufactured by Lion Specialty Chemicals Co., Ltd.; 0.5 parts by mass of an active ingredient (amine)).

### Example 14

A thermal insulating material having a thickness of 1 mm was prepared by the same method as in Example 1 except for changing dodecyltrimethylammonium chloride, which is a non-polymeric dispersant in Example 1, to octadecyl (C18)amine (“LIPOMIN 18D” manufactured by Lion Specialty Chemicals Co., Ltd.; 0.5 parts by mass of an active ingredient (amine)).

### Example 15

A thermal insulating material having a thickness of 1 mm was prepared by the same method as in Example 1 except for changing dodecyltrimethylammonium chloride, which is a non-polymeric dispersant in Example 1, to hexadecyl (C16)dimethylamine (“LIPOMIN DM16D” manufactured by Lion Specialty Chemicals Co., Ltd.; 0.5 parts by mass of an active ingredient (amine)).

### Example 16

Athermal insulating material having a thickness of 1 mm was prepared by the same method as in Example 1 except for changing AEROSIL® 200, which is hydrophilic fumed silica in Example 1, to “AEROSIL® 90G” (manufactured by Nippon Aerosil Co., Ltd.; average primary particle diameter: about 20 n; BET specific surface area: 90 m²/g).

### Example 17

A thermal insulating material having a thickness of 1 mm was prepared by the same method as in Example 1 except for changing AEROSIL® 200, which is hydrophilic fumed silica in Example 1, to “AEROSIL® 130” (manufactured by Nippon Aerosil Co., Ltd.; average primary particle diameter: about 16 n; BET specific surface area: 130 m²/g).

### Comparative Example 1

A thermal insulating material having a thickness of 1 mm was prepared by the same method as in Example 1 except for changing AEROSIL® 200, which is hydrophilic fumed silica in Example 1, to “AEROSIL® 50” (manufactured by Nippon Aerosil Co., Ltd.; average primary particle diameter: 30 n; BET specific surface area: 50 m²/g).

### Comparative Example 2

A thermal insulating material having a thickness of 1 mm was prepared by the same method as in Example 1 except for changing AEROSIL® 200, which is hydrophilic fumed silica in Example 1, to “AEROSIL® 380” (manufactured by Nippon Aerosil Co., Ltd.; average primary particle diameter: about 7 nm; BET specific surface area: 380 m²/g).

### Comparative Example 3

A thermal insulating material having a thickness of 1 mm was prepared by the same method as in Example 1 except for changing dodecyltrimethylammonium chloride, which is a non-polymeric dispersant in Example 1, to a special polycarboxylic acid polymeric surfactant (“DEMOL P” manufactured by Kao Corporation; 0.5 parts by mass of an active ingredient).

### Comparative Example 4

A thermal insulating material having a thickness of 1 mm was prepared by the same method as in Example 1 except for changing dodecyltrimethylammonium chloride, which is a non-polymeric dispersant in Example 1, to a nonionic surfactant (“SN WET S” manufactured by San Nopco Limited; 0.5 parts by mass of an active ingredient).

### Comparative Example 5

A thermal insulating material having a thickness of 1 mm was prepared by the same method as in Example 1 except for changing dodecyltrimethylammonium chloride, which is a non-polymeric dispersant in Example 1, to an amphoteric dispersant (“BYK-191” manufactured by BYK Japan KK.; 0.5 parts by mass of an active ingredient).

### Example 18

A thermal insulating material having a thickness of 1 mm was prepared by the same method as in Example 1 except for adding 1.5 parts by mass of graphite “BF-3AK” (manufactured by Chuetsu Graphite Works Co., Ltd.; average particle diameter: 3 μm) to the formulation in Example 12.

### Example 19

A thermal insulating material having a thickness of 1 mm was prepared by the same method as in Example 1 except for adding 1.5 parts by mass of carbon powder “SLC-1” (manufactured by SEC Carbon, Limited; average particle diameter: 1 μm) to the formulation in Example 12.

### Example 20

A thermal insulating material having a thickness of 1 mm was prepared by the same method as in Example 1 except for adding 1.5 parts by mass of carbon black “MA100” (manufactured by Mitsubishi Chemical Group Corporation; average particle diameter: 24 n; DBP oil absorption: 100 mL/100 g) to the formulation in Example 15.

### Example 21

A thermal insulating material having a thickness of 1 mm was prepared by the same method as in Example 1 except for changing dodecyltrimethylammonium chloride, which is a non-polymeric dispersant in Example 1, to octyl (C8)amine (“LIPOMIN 8D” manufactured by Lion Specialty Chemicals Co., Ltd.; 0.5 parts by mass of an active ingredient).

### Example 22

A thermal insulating material having a thickness of 1 mm was prepared by the same method as in Example 1 except for changing dodecyltrimethylammonium chloride, which is a non-polymeric dispersant in Example 1, to decyl (C10)dimethylamine (“FARMIN DM1098” manufactured by Kao Corporation; 0.5 parts by mass of an active ingredient).

### Example 23

Athermal insulating material having a thickness of 1 mm was prepared by the same method as in Example 1 except for changing dodecyltrimethylammonium chloride, which is a non-polymeric dispersant in Example 1, to tetradecyl (C14)amine acetate (“CATION MA” manufactured by NOF Corporation; 0.5 parts by mass of an active ingredient).

### Example 24

Athermal insulating material having a thickness of 1 mm was prepared by the same method as in Example 1 except for changing dodecyltrimethylammonium chloride, which is a non-polymeric dispersant in Example 1, to octadecyl (C18)amine acetate (“CATION SA” manufactured by NOF Corporation; 0.5 parts by mass of an active ingredient).

### Example 25

A thermal insulating material having a thickness of 1 mm was prepared by the same method as in Example 1 except for changing dodecyltrimethylammonium chloride, which is a non-polymeric dispersant in Example 1, to octyl (C8)dimethylamine (“FARMIN DM0898” manufactured by Kao Corporation; 0.5 parts by mass of an active ingredient).

### Example 26

A thermal insulating material having a thickness of 1 mm was prepared by the same method as in Example 1 except for changing dodecyltrimethylammonium chloride, which is a non-polymeric dispersant in Example 1, to stearyl propylene glycol (C21)dimethylamine (“CATINAL SHPA-80” manufactured by Toho Chemical Industry Co., Ltd.; 0.5 parts by mass of an active ingredient).

### Example 27

Athermal insulating material having a thickness of 1 mm was prepared by the same method as in Example 1 except for using the same type and amount of a non-polymeric dispersant as in Example 25, and adjusting a drying condition with combination use of a floating oven (hot-air drier) and an IR oven in such manner that the abundance ratio of the non-polymeric dispersant in the thermal insulating material is 0.0003% by mass.

Next, the octyldimethylamine content in the thermal insulating material (thermal insulating layer) thus obtained was measured by high-performance liquid chromatography-mass spectrometry (LC/MS). First, standard solutions with a plurality of concentrations of FARMIN DM0898 dissolved were prepared, and a calibration curve was created for concentrations of octyldimethylamine to area values of the LC/MS. Then, 0.4 g of the thermal insulating material was taken, added to 10 mL of methanol and agitated for 1 or more hours, thereby extracting octyldimethylamine contained in the thermal insulating material. The solution thus obtained was passed through a membrane filter (0.20 μm) and loaded in the LC/MS, and the content of octyldimethylamine in the solution was measured from the calibration curve described above. The octyldimethylamine content in the thermal insulating material was calculated from the octyldimethylamine content in 0.4 g of the thermal insulating material, and consequently revealed as 0.00029% by mass.

Conditions of the LC/MS measurement were as follows:
Measuring device: high-performance liquid chromatograph-mass spectrometer (UltiMate3000/TSQ QUANTUM ACCESS MAX, manufactured by Thermo Fisher Scientific Co., Ltd.)
Column: “L-column 3 C18” manufactured by Chemical Evaluation and Research Institute, Japan
Eluent composition: pure water (ammonium acetate added)/methanol-based gradient
Flow rate: 0.6 mL/min
Detector: MS (full scan: 100 to 500, m/z=158)
Column temperature: 40° C.
Injection volume: 5 μL
Ionization: ESI (POS.)
Ion spraying voltage: 3.0 kV
Evaporation temperature: 350° C.
Capillary temperature: 270° C.

### <Measurement of Initial Consistency of Mixture Liquid>

Consistency was measured for each of the mixture liquids provided in Examples 1 to 27 and Comparative Examples 1 to 5, as “unworked penetration” in accordance with the description in Japanese Industrial Standards JIS K 2220: 2013, “Lubricating Grease-Part 7: Test method for Cone Penetration”. In detail, a pot was prepared with such a large size that a cone weight was capable of descending without contact with the pot, and the pot was filled with a mixture liquid and placed on a penetrometer (available from Nikka-engineering KK) equipped with the weight. Next, a position of the weight was adjusted and set so as to provide contact between the weight and the mixture liquid, and the position is defined as zero. Then, the weight was moved down for 5 seconds (±0.1 seconds) under a condition at room temperature (25° C.), and a depth of penetration of the weight into the mixture liquid (mm)×10 was calculated as a consistency. As the cone weight, a standard cone defined in Japanese Industrial Standards with a total mass of 102.5 g was used, and a weight holder having a mass of 47.5±0.05 g was used. The results of the consistencies of the mixture liquids thus obtained are shown in Tables 1, 2 and 3.

<Evaluation of Dispersive Stability of Mixture Liquid (Change Rate of Consistency of Mixture Liquid after 24-Hour Stay)>

Each of the mixture liquids provided in Examples 1 to 27 and Comparative Examples 1 to 5 was left to stand for 24 hours, and then a consistency was measured in the same manner as in “Measurement of Initial Consistency of Mixture Liquid” as described above. Then, the numerical values of consistency thus obtained were substituted in the following formula: [(initial consistency of mixture liquid)−(consistency of mixture liquid after 24 hour stay)]/(initial consistency of mixture liquid)×100 [%]to calculate a change rate consistency of the post-24-hour-stay mixture liquid, thereby evaluating dispersive stability of the mixture liquids. The dispersive stabilities (the change rates of consistency) of the mixture liquids thus obtained are shown in Tables 1, 2, and 3.

### <Measuring of Compressive Deformation Rate of Thermal Insulating Material (Thermal Insulating Layer)>

A compressive deformation rate was measured for each of the thermal insulating materials (thermal insulating layers) provided in Examples 1 to 27 and Comparative Examples 1 to 5 by the following method.

Using a precision universal testing machine (AUTOGRAPH AGS-5kNX, manufactured by Shimadzu Corporation), compression test to compress a thermal insulating material at a compression rate of 0.5 mm/min was performed to measure compressive strain [%](compressive displacement/initial thickness of sample) and compressive stress [MPa]. Then, a compressive strain corresponding to a compressive stress of 2 MPa was read out and employed as a compressive deformation rate of the thermal insulating material. The compressive deformation rates of the thermal insulating materials thus obtained are shown Tables 1, 2, and 3.

### <Measuring of Thermal Conductivity of Thermal Insulating Material (Thermal Insulating Layer)>

Thermal conductivity was measured for each of the thermal insulating materials (thermal insulating layers) provided in Examples 1 to 27 and Comparative Examples 1 to 5 by the following method.

Thermal conductivity was measured separately in two ways: under a condition of 80° C. and 2 MPa and a condition of 600° C. and 2 MPa, in accordance with the description in Japanese Industrial Standards JIS A 1412-2: 1999, “Test Method for Thermal Resistance and Related Properties of Thermal Insulations-Part 2: Heat Flow Apparatus”. First, a thermal insulating material (having a thickness of 1 mm under no pressure) was cut into a size of 20 mm×20 mm to prepare a sample. The sample, a reference sample (alumina composite material (“RS-100” manufactured by ZIRCAR Refractory Composites, Inc.; thickness: 5 mm; thermal conductivity: 0.66 W/(m·K))), and a titanium plate (thickness: 0.2 mm) were prepared. Subsequently, a first thermocouple (sheath thermocouple type K (SCHSI-0), φ=0.15, class JIS1, manufactured by Chino Corporation), a titanium plate, the thermal insulating layer as a sample, a titanium plate, a second thermocouple (sheath thermocouple type K (SCHS1-0), φ=0.15, class JIS1, manufactured by Chino Corporation), a standard plate, and a third thermocouple (sheath thermocouple type K (SCHS1-0), φ=0.15, class JIS1, manufactured by Chino Corporation) were stacked and held in this order from the top onto a surface of a lower disc of a pneumatic press (manufactured by Inoto machinery Co., Ltd.), and the thermal insulating material, the standard plate, the thermocouples, and the like were closely attached to one another. The upper disc and the lower disc are then heated, and pressurized after adjusting a press so as to provide a load of 800 N (corresponding to 2 MPa). Measurement was continued under heating and pressurization until detection temperatures of the thermocouples were stable. With regard to measurement temperature, measurement was performed separately in two ways: 80° C. at an upper disc and 30° C. at a lower disc, and 600° C. at an upper disc and 40° C. at a lower disc. Stability of temperature was defined as change in temperature between before and after a duration of 10 minutes falling within A0.1° C. The thermal conductivity k1 of the thermal insulating material was calculated from the detection temperature of each of the thermocouples after stabilization of the temperature, the thickness at compression of the thermal insulating material, and the thermal conductivity and thickness of the standard sample, according to Formula (1) as follows. The thermal conductivities of the thermal insulating materials thus obtained are shown in Tables 1, 2, and 3.

$$k 1 = k 2 \times ( L 1 \times Δ T 1 ) / ( L 2 \times Δ T 2 ) \qquad ( I )$$

wherein k1 is the thermal conductivity [W/(m·K)]of the thermal insulating layer, k2 is the thermal conductivity [W/(m·K)]of the standard plate, L1 is the pressurized thickness of the thermal insulating layer, L2 is the thickness of the standard plate, ΔT1 is temperature differential between the temperature of the second thermocouple and the temperature of the third thermocouple, and ΔT2 is temperature differential between the temperature of the first thermocouple and the temperature of the second thermocouple.

### (Thermal Resistance)

The thermal resistance of a thermal insulating material was calculated from the thermal conductivity k1 and the pressurized thickness L1 described above, according to Formula (II) as follows:

$$R 1 = L 1 / k 1 \qquad ( II )$$

wherein R1 is the thermal resistance [(m²·K)/W]of the thermal insulating layer, k1 is the thermal conductivity [W/(m·K)]of the thermal insulating layer, and L1 is the pressurized thickness of the thermal insulating layer.

### <Measurement of Density of Thermal Insulating Material (Thermal Insulating Layer)>

A density was measured for each of the thermal insulating materials (thermal insulating layers) provided in Examples 1 to 27 and Comparative Examples 1 to 5 by the following method.

A thermal insulating material was cut into a size of 20 mm×20 mm and subjected to measurement of its mass and thickness, and a density [g/cm³]was calculated by dividing the mass by volume. The densities of the thermal insulating materials thus obtained are shown in Tables 1, 2, and 3.

Upward arrows in Tables 1, 2, and 3 indicate that a content in a cell filled by an arrow is the same as a content in a next higher cell.

TABLE 1

| | Silicon dioxide particles | | | | |
|---|---|---|---|---|---|
| | | | | Additive | |
| | | BET specific | Average primary | amount | |
| | | surface area | particle diameter | [parts by | Dispersant (active ingredient) |
| | Type | [m²/g] | [nm] | mass] | Type |
| Example 1 | AEROSIL200 | 200 | 12 | 100 | dodecyltrimethylammonium chloride |
| Example 2 | ↑ | ↑ | ↑ | ↑ | ↑ |
| Example 3 | ↑ | ↑ | ↑ | ↑ | ↑ |
| Example 4 | ↑ | ↑ | ↑ | ↑ | ↑ |
| Example 5 | ↑ | ↑ | ↑ | ↑ | ↑ |
| Example 6 | ↑ | ↑ | ↑ | ↑ | ↑ |
| Example 7 | ↑ | ↑ | ↑ | ↑ | hexadecyl trimethylammonium chloride |
| Example 8 | ↑ | ↑ | ↑ | ↑ | octadecyl trimethylammonium chloride |
| Example 9 | ↑ | ↑ | ↑ | ↑ | docosyl trimethylammonium chloride |
| Example 10 | ↑ | ↑ | ↑ | ↑ | dodecyl ethyldimethylammonium ethyl sulfate |
| Example 11 | ↑ | ↑ | ↑ | ↑ | dodecyl benzylmethylammonium chloride |
| Example 12 | ↑ | ↑ | ↑ | ↑ | dodecylamine |
| Example 13 | ↑ | ↑ | ↑ | ↑ | dodecyldimethylamine |
| Example 14 | ↑ | ↑ | ↑ | ↑ | octadecylamine |
| Example 15 | ↑ | ↑ | ↑ | ↑ | hexadecyldimethylamine |
| Example 16 | AEROSIL90G | 90 | 20 | ↑ | dodecyltrimethylammonium chloride |
| Example 17 | AEROSIL130 | 130 | 16 | ↑ | ↑ |

| | Dispersant (active ingredient) | | | | Thermal insulating material^{*1} | | | |
|---|---|---|---|---|---|---|---|---|
| | | Additive | | | | 80° C., | 600° C., | |
| | | amount | | | 2 MPa | 2 MPa | 2 MPa | |
| | Total | [parts | Mixture liquid^{*1} | | Compressive | Thermal | Thermal | |
| | number | by | | Dispersive | deformation | conductivity | conductivity | Density |
| | of Cs | mass] | Consistency | stability | rate | [W/(K · m)] | [W/(K · m)] | [g/cm³] |
| Example 1 | 15 | 0.5 | 111 | 18% | 15% | 0.035 | 0.064 | 0.37 |
| Example 2 | ↑ | 0.05 | 90 | 13% | 14% | 0.034 | 0.064 | 0.39 |
| Example 3 | ↑ | 1 | 102 | 26% | 14% | 0.037 | 0.066 | 0.40 |
| Example 4 | ↑ | 2 | 96 | 33% | 15% | 0.038 | 0.066 | 0.41 |
| Example 5 | ↑ | 3 | 70 | 36% | 14% | 0.040 | 0.068 | 0.38 |
| Example 6 | ↑ | 5 | 78 | 36% | 15% | 0.042 | 0.070 | 0.42 |
| Example 7 | 19 | 0.5 | 109 | 39% | 15% | 0.037 | 0.065 | 0.42 |
| Example 8 | 21 | ↑ | 99 | 33% | 15% | 0.037 | 0.065 | 0.39 |
| Example 9 | 25 | ↑ | 90 | 25% | 15% | 0.037 | 0.069 | 0.42 |
| Example 10 | 16 | ↑ | 95 | 10% | 16% | 0.037 | 0.068 | 0.40 |
| Example 11 | 21 | ↑ | 98 | 25% | 15% | 0.037 | 0.068 | 0.44 |
| Example 12 | 12 | ↑ | 136 | 22% | 15% | 0.040 | 0.070 | 0.46 |
| Example 13 | 14 | ↑ | 103 | 6% | 16% | 0.044 | 0.075 | 0.41 |
| Example 14 | 18 | ↑ | 134 | 21% | 14% | 0.040 | 0.070 | 0.44 |
| Example 15 | 18 | ↑ | 89 | <1% | 14% | 0.042 | 0.072 | 0.42 |
| Example 16 | 15 | ↑ | 130 | 15% | 21% | 0.039 | 0.069 | 0.41 |
| Example 17 | ↑ | ↑ | 117 | 15% | 18% | 0.036 | 0.065 | 0.38 |

^{*1}containing 20 parts by mass of the glass fiber CS 6J-888 (average fiber length: 6 mm, average fiber diameter: 11 μm) as inorganic fiber, in addition to components shown in the table (common to Examples 1 to 17).

TABLE 2

| | Silicon dioxide particles | | | | Dispersant (active ingredient) | | |
|---|---|---|---|---|---|---|---|
| | | BET | Average | Additive | | | Additive |
| | | specific | primary | amount | | | amount |
| | | surface | particle | [parts | | Total | [parts |
| | | area | diameter | by | | number | by |
| | Type | [m²/g] | [nm] | mass] | Type | of Cs | mass] |
| Comparative | AEROSIL50 | 50 | 30 | 100 | dodecyltrimethylammonium | 15 | 0.5 |
| Example 1 | | | | | chloride | | |
| Comparative | AEROSIL380 | 380 | 7 | ↑ | ↑ | ↑ | ↑ |
| Example 2 | | | | | | | |
| Comparative | AEROSIL200 | 200 | 12 | ↑ | DEMOL P, special | — | ↑ |
| Example 3 | | | | | polycarboxylic acid-type | | |
| | | | | | polymeric surfactant | | |
| Comparative | ↑ | ↑ | ↑ | ↑ | SN WET S, nonionic | — | ↑ |
| Example 4 | | | | | surfactant | | |
| Comparative | ↑ | ↑ | ↑ | ↑ | BYK-191, amphoteric | — | ↑ |
| Example 5 | | | | | dispersant | | |

| | | | Thermal insulating material^{*1} | | | |
|---|---|---|---|---|---|---|
| | | | | 80° C., | 600° C., | |
| | | | 2 MPa | 2 MPa | 2 MPa | |
| | Mixture liquid^{*1} | | Compressive | Thermal | Thermal | |
| | | Dispersive | deformation | conductivity | conductivity | Density |
| | Consistency | stability | rate | [W/(K · m)] | [W/(K · m)] | [g/cm³] |
| Comparative | 200 | 10% | 25% | 0.045 | 0.075 | 0.45 |
| Example 1 | | | | | | |
| Comparative | 57 | 36% | 25% | 0.034 | 0.064 | 0.37 |
| Example 2 | | | | | | |
| Comparative | 58 | 35% | 17% | 0.039 | 0.069 | 0.41 |
| Example 3 | | | | | | |
| Comparative | 61 | <1% | 22% | 0.039 | 0.069 | 0.40 |
| Example 4 | | | | | | |
| Comparative | 60 | 35% | 16% | 0.035 | 0.065 | 0.39 |
| Example 5 | | | | | | |

^{*1}containing 20 parts by mass of the glass fiber CS 6J-888 (average fiber length: 6 mm, average fiber diameter: 11 μm) as inorganic fiber, in addition to components shown in the table (common to Comparative Examples 1 to 5).

TABLE 3

| | Silicon dioxide particles | | Dispersant (active ingredient) | | | |
|---|---|---|---|---|---|---|
| | | Additive | | | Additive | |
| | | amount | | | amount | |
| | | [parts | | Total | [parts | |
| | | by | | number | by | Other inorganic particles |
| | Type | mass] | Type | of Cs | mass] | Type |
| Example 18 | AEROSIL 200 | 100 | dodecylamine | 12 | 0.5 | graphite |
| Example 19 | ↑ | ↑ | ↑ | ↑ | ↑ | carbon powder |
| Example 20 | ↑ | ↑ | ↑ | ↑ | ↑ | carbon black |
| Example 21 | ↑ | ↑ | octylamine | 8 | ↑ | — |
| Example 22 | ↑ | ↑ | decyldimethylamine | 12 | ↑ | — |
| Example 23 | ↑ | ↑ | tetradecylamine | 14 | ↑ | — |
| | | | acetate | | | |
| Example 24 | ↑ | ↑ | octadecylamine | 18 | ↑ | — |
| | | | acetate | | | |
| Example 25 | ↑ | ↑ | octyldimethylamine | 10 | ↑ | — |
| Example 26 | ↑ | ↑ | stearyl propylene | 23 | ↑ | — |
| | | | glycol dimethylamine | | | |
| Example 27 | ↑ | ↑ | octyldimethylamine | 10 | ↑ | — |

| | Other inorganic | | | | | | |
|---|---|---|---|---|---|---|---|
| | particles | | | Thermal insulating material^{*1} | | | |
| | Additive | | | | 80° C., | 600° C., | |
| | amount | | | 2 MPa | 2 MPa | 2 MPa | |
| | [parts | Mixture liquid^{*1} | | Compressive | Thermal | Thermal | |
| | by | | Dispersive | deformation | conductivity | conductivity | Density |
| | mass] | Consistency | stability | rate | [W/(K · m)] | [W/(K · m)] | [g/cm³] |
| Example 18 | 1.5 | 200 | 20% | 18% | 0.038 | 0.062 | 0.44 |
| Example 19 | 1.5 | 150 | 22% | 20% | 0.038 | 0.063 | 0.42 |
| Example 20 | 1.5 | 156 | 21% | 21% | 0.037 | 0.066 | 0.40 |
| Example 21 | — | 125 | <1% | 16% | 0.040 | 0.070 | 0.48 |
| Example 22 | — | 118 | 9% | 18% | 0.038 | 0.064 | 0.38 |
| Example 23 | — | 117 | 27% | 18% | 0.038 | 0.066 | 0.39 |
| Example 24 | — | 117 | 32% | 18% | 0.038 | 0.070 | 0.40 |
| Example 25 | — | 129 | 12% | 16% | 0.036 | 0.064 | 0.40 |
| Example 26 | — | 109 | 13% | 21% | 0.036 | 0.064 | 0.37 |
| Example 27 | — | 129 | 12% | 20% | 0.036 | 0.069 | 0.42 |

^{*1}containing 20 parts by mass of the glass fiber CS 6J-888 (average fiber length: 6 mm, average fiber diameter: 11 μm) as inorganic fiber, in addition to components shown in the table (common to Examples 18 to 26).

As shown in Tables 1, 2, and 3, Examples 1 to 17 and Examples 18 to 27, which used silicon dioxide particles having a BET specific surface area of 90 m²/g or more and less than 380 m²/g, inorganic fiber, and at least one kind of non-polymeric dispersant represented by Formula (A1), (A2), (A3), or (A4) as described above, provided reduction in increased viscosity of a mixture liquid (high values of consistency), and excellent productivity. By contrast, Comparative Example 1, which employed silicon dioxide particles having too small a BET specific surface area, provided relatively high thermal conductivity. Comparative Example 2, which employed silicon dioxide particles having too large a BET specific surface area, and Comparative Examples 3 to 5, which only used a materials corresponding to none of Formulae (A1) to (A4) as a dispersant, provided a mixture liquid with evidently higher viscosity (lower consistency) as compared to Examples.

### <<Experimental Example 2>>

### (Example 1B)

In Example 1, the applied thickness of a mixture liquid is changed to 4 mm, and compress shaping was performed with a hot press machine to form a sheet with a thickness of 2 mm and a density of 0.3 g/cm³ to 0.5 g/cm³. Except for these, a thermal insulating material (thermal insulating layer) having a thickness of 2 mm was prepared in the same manner as in Example 1.

### (Examples 4B,12B,18B to 20B, and 22B to 26B)

In each of Examples 4, 12, 18 to 20, and 22 to 26, the applied thickness of a mixture liquid is changed to 4 mm, and compress shaping was performed with a hot press machine to form a sheet with a thickness of 2 mm and a density of 0.3 g/cm³ to 0.5 g/cm³. Except for these, thermal insulating materials (thermal insulating layers) having a thickness of 2 mm according to Examples 4B, 12B, 18B to 20B, and 22B to 26B were prepared in the same manner as in Example 1.

Thermal conductivity and densities were measured for the thermal insulating materials (thermal insulating layers) thus obtained, in the same manner as in Experimental Example 1 in two ways: under a condition of 80° C. and 2 MPa and a condition of 600° C. and 2 MPa. In the results, measurement under a condition of 80° C. and 2 MPa showed that Example 1B exhibited a comparable thermal conductivity with the thermal conductivity in Example 1, and the same applied to Examples 4B, 12B, 18B to 20B, and 22B to 26B. By contrast, measurement under a condition of 600° C. and 2 MPa revealed a tendency that a thickness of a thermal insulating material variously affects thermal conductivity depending on presence or absence of other inorganic particles. The measurement results of thermal conductivity under a condition of 600° C. and 2 MPa were compered between Examples 1B, 4B, 12B, 18B to 20B, and 22B to 26B, and their corresponding examples of Example 1, 4, 12, 18 to 20, and 22 to 26, and shown in Table 4 together with the density of each of the thermal insulating materials (thermal insulating layers).

TABLE 4

| | | | Thermal insulating material | | |
|---|---|---|---|---|---|
| | | | | 600° C., | |
| | | | | 2 MPa | |
| | Other inorganic particles | | | Thermal | |
| | | Additive | | conduc- | |
| | | amount | | tivity | |
| | | [parts by | Thick- | [W/ | Density |
| | Type | mass] | ness | (K · m)] | [g/cm³] |
| Example 1 | — | — | 1 mm | 0.064 | 0.37 |
| Example 1B | | | 2 mm | 0.070 | 0.37 |
| Example 4 | — | — | 1 mm | 0.066 | 0.41 |
| Example 4B | | | 2 mm | 0.072 | 0.40 |
| Example 12 | — | — | 1 mm | 0.070 | 0.46 |
| Example 12B | | | 2 mm | 0.074 | 0.38 |
| Example 18 | graphite | 1.5 | 1 mm | 0.062 | 0.44 |
| Example 18B | | | 2 mm | 0.062 | 0.40 |
| Example 19 | carbon | 1.5 | 1 mm | 0.063 | 0.42 |
| Example 19B | powder | | 2 mm | 0.063 | 0.40 |
| Example 20 | carbon | 1.5 | 1 mm | 0.066 | 0.40 |
| Example 20B | black | | 2 mm | 0.066 | 0.39 |
| Example 22 | — | — | 1 mm | 0.064 | 0.38 |
| Example 22B | | | 2 mm | 0.072 | 0.38 |
| Example 23 | — | — | 1 mm | 0.066 | 0.39 |
| Example 23B | | | 2 mm | 0.072 | 0.39 |
| Example 24 | — | — | 1 mm | 0.070 | 0.40 |
| Example 24B | | | 2 mm | 0.073 | 0.40 |
| Example 25 | — | — | 1 mm | 0.064 | 0.40 |
| Example 25B | | | 2 mm | 0.075 | 0.40 |
| Example 26 | — | — | 1 mm | 0.064 | 0.37 |
| Example 26B | | | 2 mm | 0.070 | 0.37 |

The results shown in Table 4 reveals that Examples 18 to 20 and Examples 18B to 20B, which represent thermal insulating materials (thermal insulating layers) shaped from a mixture containing other inorganic particles (in this context, carbon-based particles), exhibited no substantive change in a thermal conductivity value at 600° C. and 2 MPa with a thickness of either 1 mm or 2 mm, indicating reduction in increased thermal conductivity due to increased thickness as compared to other Examples. This is considered to be due to presence of other inorganic particles and thereby reduction in thermal radiation in Examples 18 to 20 and Examples 18B to 20B.

Although specific examples of the present invention have been described in detail so far, these are merely for illustrations and do not limit the scope of the claims. The art recited in the claims includes various modifications and changes made to the specific examples illustrated above.

### REFERENCE SIGNS LIST

1 thermal insulating material
10, 10A, 10B, 521 thermal insulating layer
20, 20A, 20B, 522 cushioning layer
30, 523 covering material (covering layer)
31A, 31B resin film
32 sealing part
33 vent hole
34 venting film
40 adhesive layer
50 battery module
51 battery cell

1. A thermal insulating material comprising:
a thermal insulating layer comprising silicon dioxide particles having a BET specific surface area of 90 m²/g or more and less than 380 m²/g, inorganic fiber, and at least one kind of non-polymeric dispersant represented by Formula (A1), (A2), (A3), or (A4) as follows: 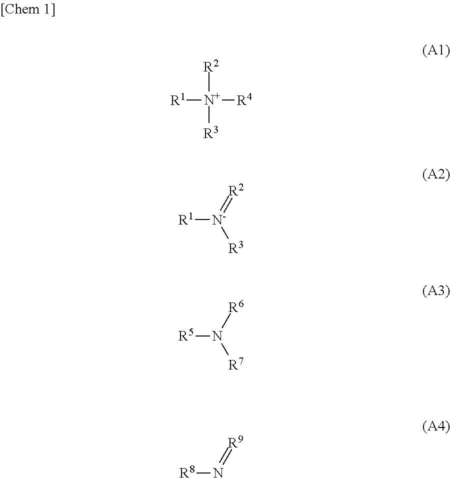
wherein, in Formulae (A1) and (A2), R¹, R², R³, and R⁴ each independently represents a hydrocarbon group optionally including a hetero atom; a total number of carbon atoms derived by combining hydrocarbon groups R¹, R², R³, and R⁴ is 8 to 40; and hydrocarbon groups R¹, R², R³, and R⁴ optionally bind to one another to form a cyclic structure;
wherein, in Formula (A3), R⁵ represents a hydrocarbon group optionally including a hetero atom; R⁶ and R⁷ each independently represents a hydrogen atom or a hydrocarbon group optionally including a hetero atom; a total number of carbon atoms derived by combining hydrocarbon groups R⁵, R⁶, and R⁷ is 8 to 40; and hydrocarbon groups R⁵, R⁶, and R⁷ optionally bind to one another to form a cyclic structure; and
wherein, in Formula (A4), R⁸ and R⁹ each independently represents a hydrocarbon group optionally including a hetero atom; a total number of carbon atoms derived by combining hydrocarbon groups R⁸ and R⁹ is 8 to 40; and hydrocarbon groups R⁸ and R⁹ optionally bind to one another to form a cyclic structure.

2. The thermal insulating material according to claim 1, wherein the non-polymeric dispersant is present in a content of 0.01% by mass to 5% by mass in the thermal insulating layer.

3. The thermal insulating material according to claim 1, wherein the silicon dioxide particles is at least one kind selected from the group consisting of dry silica, wet silica, and silica aerogel.

4. The thermal insulating material according to claim 1, wherein the silicon dioxide particles is at least one kind selected from the group consisting of hydrophilic fumed silica and hydrophobic fumed silica.

5. The thermal insulating material according to claim 1, wherein the silicon dioxide particles has an average primary particle diameter of 100 nm or less.

6. The thermal insulating material according to claim 1, wherein the inorganic fiber is at least one kind selected from the group consisting of glass fiber and biosoluble inorganic fiber.

7. The thermal insulating material according to claim 1, wherein the thermal insulating layer has a density of 0.2 g/cm³ to 0.5 g/cm³.

8. The thermal insulating material according to claim 1, wherein the thermal insulating layer has a thermal conductivity of 0.045 W/(m·K) or less under a pressurized condition of 2 MPa at 80° C.

9. The thermal insulating material according to claim 1, wherein the thermal insulating layer has a thermal conductivity of 0.08 W/(m·K) or less under a pressurized condition of 2 MPa at 600° C.

10. The thermal insulating material according to claim 1, further comprising a covering layer formed of a resin film,
wherein the thermal insulating layer and the covering layer are stacked.

11. The thermal insulating material according to claim 10,
wherein the thermal insulating material comprises two or more of the covering layers forming a stack, and
wherein the two or more covering layers sandwich and enclose the thermal insulating layer among themselves in a thickness direction, and seal a gap between the covering layers.

12. The thermal insulating material according to claim 11, wherein the covering layer has a vent hole to connect the gap to an exterior space.

13. The thermal insulating material according to claim 1, the thermal insulating material being placed between cells in a battery module.

14. A method of producing a thermal insulating material comprising:
mixing silicon dioxide particles, inorganic fiber, and a non-polymeric dispersant represented by Formula (A1), (A2), (A3), or (A4) as follows in a solvent to prepare a mixture liquid,
applying the mixture liquid prepared in the mixing to provide an applied film, and
shaping the applied film provided in the applying step to provide a thermal insulating layer: 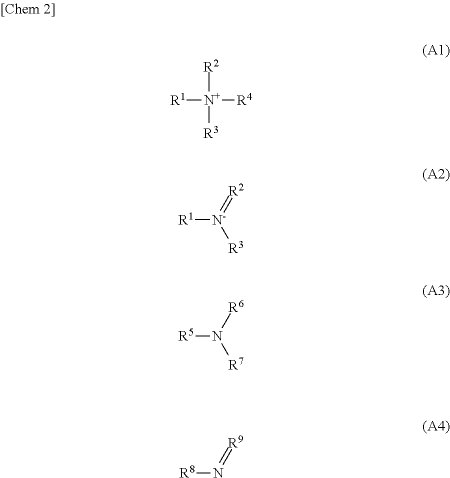
wherein, in Formulae (A1) and (A2), R¹, R², R³, and R⁴ each independently represents a hydrocarbon group optionally including a hetero atom; a total number of carbon atoms derived by combining hydrocarbon groups R¹, R², R³, and R⁴ is 8 to 40; and hydrocarbon groups R¹, R², R³, and R⁴ optionally bind to one another to form a cyclic structure;
wherein, in Formula (A3), R⁵ represents a hydrocarbon group optionally including a hetero atom; R⁶ and R⁷ each independently represents a hydrogen atom or a hydrocarbon group optionally including a hetero atom; a total number of carbon atoms derived by combining hydrocarbon groups R⁵, R⁶, and R⁷ is 8 to 40; and hydrocarbon groups R⁵, R⁶, and R⁷ optionally bind to one another to form a cyclic structure; and
wherein, in Formula (A4), R⁸ and R⁹ each independently represents a hydrocarbon group optionally including a hetero atom; a total number of carbon atoms derived by combining hydrocarbon groups R⁸ and R⁹ is 8 to 40; and hydrocarbon groups R⁸ and R⁹ optionally bind to one another to form a cyclic structure.

15. The method of producing a thermal insulating material according to claim 14, wherein the non-polymeric dispersant is added to the mixture liquid in an amount of 0.05 parts by mass to 5 parts by mass relative to 100 parts by mass of the silicon dioxide particles.

16. The method of producing a thermal insulating material according to claim 14, wherein the solvent is a protic solvent.

17. The method of producing a thermal insulating material according to claim 14, wherein the solvent has a surface tension of less than 73 mN/m.
